(19) United States
(12) Patent Application Publication
(10) Pub. No.: US 2006/0208671 A1
(43) Pub. Date: Sep. 21, 2006

(54) Display device

(75) Inventors: Toshifumi Ozaki, Koganei (JP); Masahisa Tsukahara, Fujisawa (JP); Toshiki Misonou, Ichihara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/373,105

(22) Filed: Mar. 13, 2006

(30) Foreign Application Priority Data
Mar. 15, 2005 (JP) 2005-073142
Mar. 15, 2005 (JP) 2005-072779

(51) Int. Cl. G09G 1/04

(52) U.S. Cl. 315/371

(57) ABSTRACT

A display device of the invention includes horizontal lines, longitudinal lines, electron emission elements, and a scanning circuit which performs the selection of the horizontal lines. The scanning circuit includes a non-selection voltage switch, a correction selection voltage switch, and an output voltage detection switch for the selected horizontal line for every horizontal line. The display device also includes a differential amplifier which is connected to a correction selection voltage input line, a horizontal line selection voltage line, and a correction selection voltage output line for every plurality of horizontal lines. The invention can suppress a voltage drop of the horizontal lines and, at the same time, can suppress the brightness irregularities of the display device.

### CROSS-REFERENCE TO RELATED APPLICATION

The present application claims priority from Japanese application JP2005-073142 filed on Mar. 15, 2005, and Japanese application JP2005-072779 filed on Mar. 15, 2005, the content of which is hereby incorporated by references into this application.

### BACKGROUND OF THE INVENTION

1. Field of the Invention

The present invention relates to a scanning circuit which performs the selection of scanning lines of display panel having a particularly of scanning line (horizontal line) and a plurality of longitudinal line.

The present invention relates to a display device which is capable of correcting a voltage drop in a scanning line (horizontal line), and more particularly to a display device which uses MIM type electron emission elements.

2. Description of the Related Art

Heretofore, as a cold cathode electron emission element, there has been known a metal/insulator layer/metal type electron emission element (hereinafter referred to as “MIM type electron emission element”), for example. The MIM type electron emission element emits electrons from a surface of an electrode when a voltage is applied to upper and lower electrodes which sandwich an insulation layer therebetween.

In this MIM type electron emission element, approximately 95% of electrons which are emitted from the lower electrode are not emitted as electrons and flow in the upper electrode. Accordingly, a voltage drop is generated in horizontal line which is connected to the upper electrode thus generating brightness irregularities. To prevent the generation of brightness irregularities, there has been studied a method which corrects a voltage of the longitudinal line (longitudinal line) which is connected to the lower electrode.

However, in the MIM type electron emission element, a parasitic capacitance of the longitudinal line is large and hence, there has been a drawback that due to the increase of an amplitude of the longitudinal line voltage attributed to the voltage correction, the power consumption of a data driver which constitutes a modulation circuit for driving the longitudinal line is increased.

In patent document 1 (JP-A-2004-86130), there is described a horizontal line selection voltage correction circuit which corrects an input voltage to a scanning circuit output circuit by feedbacking a scanning circuit output voltage.

Further, in the patent document 1 and patent document 2 (Japanese Patent 2619001), there is described a horizontal line selection voltage correction circuit which suppresses the voltage fluctuation of a horizontal line selection voltage due to a voltage drop which is generated by an electric current which flows in a horizontal line and an output ON resistance of a scanning circuit which is connected to the horizontal line.

The correction circuit shown in FIG. 17 which is described in the above-mentioned patent document 1 includes the resistance feed back which uses an operational amplifier 205. As a result, a voltage of an output terminal 207 is not equal to a reference voltage Ref and hence, a voltage drop which is generated due to an electric current which flows in the horizontal line and the output ON resistance of the scanning circuit cannot be corrected.

Further, a correction circuit shown in FIG. 26 which is described in the above-mentioned patent document 1 includes a voltage follower which uses an operational amplifier 503 for each horizontal line outputting and a gate of a FET 502 is driven by the operational amplifier 503 such that an output 501 assumes a fixed value. However, the correction circuit is operated to set a drain-source voltage of the FET 502 to a fixed value and hence, a gate-source voltage is changed due to an electric current which flows in the horizontal line whereby the ON resistance is largely changed and a time constant of the change of horizontal line voltage is changed. Further, a case in which multi-output horizontal lines are corrected by a common operational amplifier is not taken into consideration.

Further, in the above-mentioned patent document 3 (Japanese Patent 3311201), the voltage drop correction attributed to the output ON resistance of the scanning circuit is performed by the voltage correction of a pulse which is outputted to the longitudinal line and hence, as described previously, there arises a drawback that due to the increase of an amplitude of the longitudinal line voltage attributed to the voltage correction, the power consumption of a data driver which constitutes a modulation circuit for driving the longitudinal line is increased.

The above-mentioned patent documents 2,3 disclose only the correction of the voltage drop which is generated by the electric current which flows in the horizontal line and the output ON resistance of the scanning circuit and the correction of the voltage drop which is generated due to the horizontal line resistance is not taken into consideration. Further, these patent documents also fail to take the correction of voltage drop which is generated due to the output ON resistance when a scanning circuit is formed on both sides of a display panel and the same horizontal line is simultaneously driven from both sides into consideration.

### SUMMARY OF THE INVENTION

The invention can perform the voltage correction with high accuracy while suppressing the increase of the power consumption of a data driver attributed to the increase of amplitude of horizontal lines by correction.

A display device of the invention includes a display panel having a back plate on which a plurality of horizontal lines, a plurality of longitudinal lines and a plurality of electron emission elements which are connected with the horizontal lines and the longitudinal lines are formed and a face substrate to which an anode voltage is applied, a scanning circuit which performs the selection of the horizontal lines, and a modulation circuit which applies a modulation voltage to the longitudinal lines. The scanning circuit includes a non-selection switch which is provided between a scanning circuit output point and a power source line and turns on and off a non-selection voltage, a selection switch which is provided between the scanning circuit output point and a correction selection voltage generating circuit output line and turns on or off a correction selection voltage, and a detection switch which is provided between the scanning circuit output point and a correction selection voltage generating circuit input line and detects an output voltage of the selected horizontal line for every horizontal line and, at the same time, a correction selection voltage generating circuit having a differential amplifier which connects a first input thereof to the selection voltage generating circuit input line, a second input thereof to a line to which the horizontal line selection voltage is applied, and an output thereof to the correction selection voltage generating circuit output line for every line of the plurality of horizontal lines.

Due to an high input impedance of the differential amplifier, a steady-state current does not flow into the correction selection voltage generating circuit input line and the detection switch and hence, the first input voltage of the differential amplifier becomes equal to the scanning circuit output point voltage. As a result, without depending on an amount of voltage drop which is generated by an electric current which flows in the horizontal line and the resistance of the correction selection voltage generating circuit output line and the selection switch, an output voltage of the differential amplifier is corrected such that the scanning circuit output point voltage becomes the horizontal line selection voltage applied to the second input of the differential amplifier. Accordingly, it is possible to correct the voltage drop which is generated by the electric current which flows in the horizontal line and the output ON resistance of the scanning circuit with high accuracy. Further, a source voltage of the selection switch is changed due to an electric current which flows in the horizontal line and hence, it is possible to decrease a change of a gate-source voltage thus decreasing the ON resistance and a change of time constant.

In addition, because the correction selection voltage becomes higher voltage than the selection voltage when the output voltage of the scanning circuit rises from non-selection voltage to the selection voltage, the time constant of the rise can be shortened.

Since a feedback switch is turned on during a non-selection period in which both of the selection switch and the detection switch are turned off, it is possible to prevent a phenomenon that when the selected horizontal line is changed over, a feedback path is disconnected and the output of the differential amplifier becomes unstable.

By delaying an OFF time of the feedback switch than ON times of the selection switch and the detection switch of the selected horizontal line, there is no possibility that when the potential is sharply changed initially when the output voltage of the scanning circuit is elevated from the non-selection voltage to the selection voltage, the change of the input voltage of the differential amplifier is not delayed with respect to the output voltage of the differential amplifier and hence, it is possible to reduce overshoot of the selection voltage output in horizontal line.

Further, the display device of the invention includes a correction selection voltage generating circuit which performs the correction of the selected horizontal line such that the voltage of the scanning circuit output point voltage assumes a fixed value without depending on display data, and the modulation circuit output outputs a modulation voltage which is corrected based on a correction value for compensating for a voltage drop in each horizontal line portion which is determined corresponding to a display pattern while setting an amount of voltage drop at a scanning circuit output point to zero.

A total electric current which flows toward electron emission elements at end portions of the horizontal line from the scanning circuit output point is obtained by superposing components which flow toward the respective electron emission elements from the scanning circuit output point out of the electric current which flows from horizontal lines to longitudinal lines of the respective electron emission elements, the electric current which flows from the horizontal lines to the longitudinal lines up to the mth electron emission element from the scanning circuit output point is sequentially added, the added electric current is subtracted from the total electric current thus obtaining an electric current which flows between neighboring pixels (the inter-neighboring-pixel electric current is obtained by subtracting the added electric current from the total electric current), and a resistance value per one pixel is multiplied to a value which is obtained by sequentially adding the inter-neighboring-pixel electric currents up to the mth electron emission element from the scanning circuit output point thus obtaining an inter-neighboring-pixel voltage drop, and a voltage drop in each electron emission element is obtained.

Further, a display device of the invention includes a display panel having a back plate on which a plurality of horizontal lines, a plurality of longitudinal lines and a plurality of electron emission elements which are arranged at respective intersecting points of the horizontal lines and the longitudinal lines and face substrate to which an anode voltage is applied, a scanning circuit which performs the selection of the horizontal lines, and a modulation circuit which applies a modulation voltage to the longitudinal lines, wherein the scanning circuit includes a correction selection voltage generating circuit which is provided to both sides of a display panel for simultaneously driving the same line from both sides and performs the correction such that voltages of left and right scanning circuit output points of the horizontal line selected for respective left and right scanning circuits assume predetermined values, and the modulation circuit outputs a modulation voltage which is corrected based on a correction value for compensating voltage drops of the respective horizontal line portions determined corresponding to a display pattern.

According to the invention, the output voltage of the modulation circuit no more contains the correction of the voltage drop generated due to the scanning driver ON resistance and hence, it is possible to decrease the amplitude of the output voltage, the power consumption can be reduced, and the number of correction gray scales in the data driver is reduced.

Further, when the scanning circuit is formed on both sides of the display panel and the same line is driven simultaneously from both sides, it is possible obtain the similar advantageous effects.

A sum-of-product operation within one horizontal scanning period becomes a sum-of-product operation of N×N for calculating the total electric current. Compared to the conventional method described in patent document 1 in which the sum-of-product operation of N×N is performed N times, the sum-of-product operation can be drastically reduced by 1/N times.

Further, from the output point of the scanning circuit to the electronic emission element which is arranged at the end portion of the horizontal line, it is possible to compensate for the voltage drop attributed to the resistance of the horizontal line.

Still further, even when the resistance of the horizontal line differs for every line due to the line arrangement or the like from the output point of the scanning circuit to the electronic emission element which is arranged at the end portion of the horizontal line, it is possible to prevent the generation of the deterioration of image quality.

As has been described above, according to the display device of the invention, it is possible to realize the high image quality and the low-power-consumption characteristics. Still further, since the number of sum-of-product operations can be reduced, the sum-of-product operations can be performed with a simple hardware.

According to the display device of the invention, it is possible to realize the high image quality characteristics which exhibit the small correction error and the light emitting time with a little signal dependency.

Further, according to the display device of the invention, the output of the differential amplifier can be stabilized thus preventing the generation of irregularities of the images.

Still further, according to the display device of the invention, the overshooting of the selection voltage outputted to the horizontal line can be reduced and a light emitting amount can be controlled with high accuracy.

### BRIEF DESCRIPTION OF THE DRAWINGS

FIG. 1 is an overall constitutional view (1) according to the invention;

FIG. 2 is a constitutional view of a data driver in a modulation circuit shown in FIG. 1;

FIG. 3 is a constitutional view of a scanning driver in a scanning circuit shown in FIG. 1;

FIG. 4 is a detailed view of a correction voltage generation circuit 34 and an output circuit 31 shown in FIG. 3;

FIG. 5 is a driving timing chart (1) of the data driver and the scanning driver shown in FIG. 2 and FIG. 3;

FIG. 6 is an equivalent circuit diagram (1) of the horizontal lines shown in FIG. 1;

FIG. 7 is a circuit diagram of a voltage drop correction circuit mounted in a display controller shown in FIG. 1 (1);

FIG. 8 is another driving timing chart (2) of the data driver and the scanning driver shown in FIG. 2 and FIG. 3;

FIG. 9 is another equivalent circuit diagram (2) of a horizontal line shown in FIG. 1;

FIG. 10 is a circuit diagram of another voltage drop correction circuit (2) mounted in a display controller shown in FIG. 1;

FIG. 11 is another overall constitutional view (2) according to the invention;

FIG. 12 is an overall constitutional view (3) according to the invention;

FIG. 13 is a constitutional view (2) of a scanning driver in a scanning circuit;

FIG. 14 is a driving timing chart of a data driver and a scanning driver;

FIG. 15 is a circuit diagram (3) of another voltage drop correction circuit mounted in the display controller;

FIG. 16 is a detailed view of a correction voltage generating circuit 34;

FIG. 17 is a circuit diagram of a reference voltage generating circuit mounted in the display controller 8;

FIG. 18 is another constitutional view (3) of the scanning driver in the scanning circuit;

FIG. 19 is a detailed view of an output circuit 91 and a correction selection voltage generating circuit 94;

FIG. 20 is an arrangement view of lines between a unit 91-1 of an output circuit and the correction selection voltage generating circuit 94;

FIG. 21 is a circuit diagram of another voltage drop correction circuit (4) mounted in the display controller;

FIG. 22 is a circuit diagram of another voltage drop correction circuit (5) mounted in the display controller; and

FIG. 23 is another overall constitutional view (4) according to the invention.

### PREFERRED EMBODIMENTS OF THE INVENTION

Embodiments of the invention are explained hereinafter in conjunction with attached drawings.

### Embodiment 1

FIG. 1 is a block diagram showing the whole circuit constitution (1) of this embodiment. A display panel 4 includes a back plate, a face plate and a side wall (not shown in the drawing). The back plate includes longitudinal lines 1 which extend in the longitudinal direction (Y direction), horizontal lines 2 which extend in the lateral direction (X direction), and each electron emission element 3 which is connected to one longitudinal line and one horizontal line. A plurality of longitudinal lines is arranged in the lateral direction, while a plurality of horizontal lines are arranged in the longitudinal direction. An MIM type electron emission element can be used as the electron emission element. The face plate includes phosphor films 10 and a metal back 11 which is formed to cover the phosphor films 10. A surface of the face plate on which the electron emission elements 3 are formed and a surface of the back plate on which a phosphor screen is formed face each other in an opposed manner, and the side wall is arranged between the opposing surfaces of the face plate and the back plate. The inside of the panel is evacuated.

The phosphor films 10 are arranged to face the respective longitudinal lines of the MIM type electron emission elements 3 in an opposed manner. Further, the phosphor films 10 are formed of films of three primary colors consisting of red, green and blue. Numeral 5 indicates a modulation circuit which outputs a modification signal to the longitudinal lines, while numerals 6-1, 6-2 indicate scanning circuit which are arranged at both sides of the display panel 4 and perform the horizontal line selection.

A driver power source 7 supplies a high power source voltage VGHH, a non-selection voltage VGL and a logic circuit voltage Vcc to the scanning circuits 6-1, 6-2. Further, the driver power source 7 supplies a maximum light emitting voltage VEL, a non-light-emitting voltage VEH and a logic circuit voltage Vcc to the modulation circuit 5 and a maximum light emitting voltage VEL, a non-light-emitting voltage VEH, a high power source voltage VGHH and a logic circuit voltage Vcc to the display controller 8.

The display controller 8 outputs a vertical clock VCLK, a start pulse VIO and a output changeover signal STB as control signals to the scanning circuits 6-1, 6-2. Further, the display controller 8 outputs a horizontal clock HCLK, a start pulse HIO, an output changeover signal STB, reference voltages for the modulation circuit V0 to VM and the 3-output display data D0, D1, D2 of n bits corresponding to red, green, and blue to the modulation circuit 5 as control signals.

These control signals and all signals except for the reference voltages V0 to VM for the modulation circuit have an amplitude of the logic circuit voltage Vcc. Further, an anode power source 9 supplies an anode voltage VA to a metal back 11 to allow the phosphor film 10 to emit light.

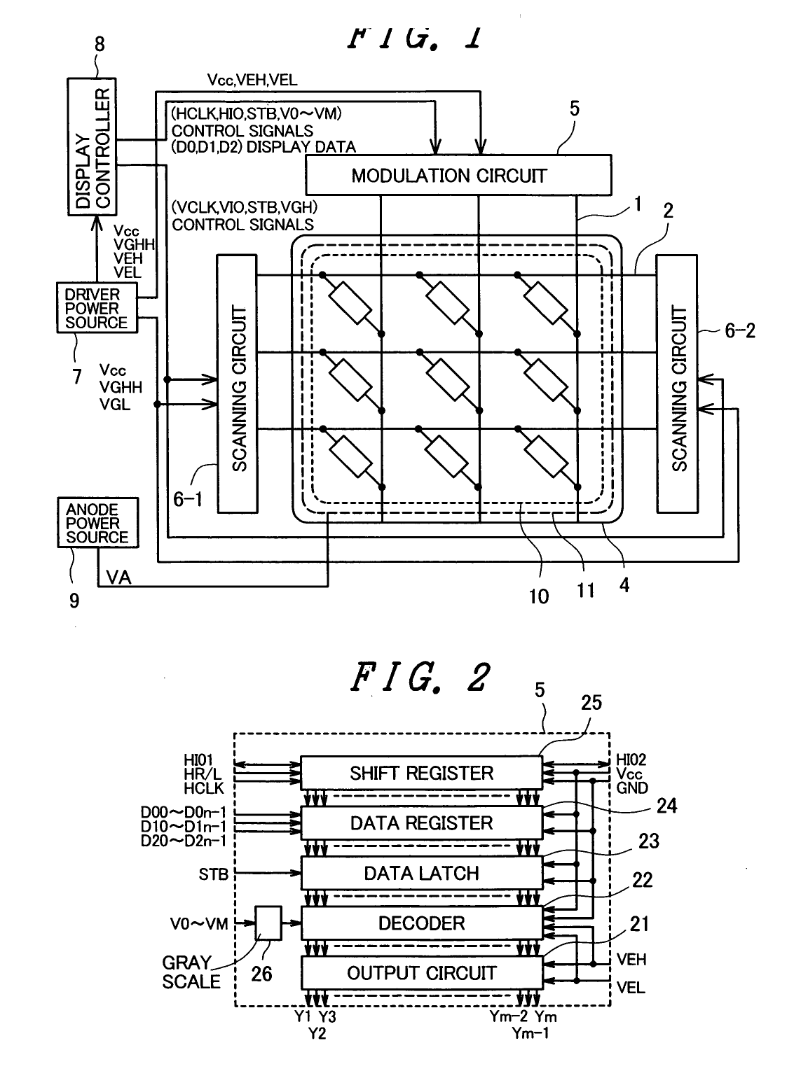

FIG. 2 is a constitutional view of a data driver which constitutes the modulation circuit 5 shown in FIG. 1. The modulation circuit 5 is constituted of the data drivers connected in series.

In FIG. 2, numeral 25 indicates a shift register which generates a latch signal for fetching the display data, numeral 24 indicates a data register which sequentially fetches 3-output display data D00 to Don-1, D10 to D1n-1, D20 to D2n-1 of n bits corresponding to red, green and blue which are simultaneously imputed from the display controller, numeral 23 indicates a data latch which fetches the display data of data register 24 in synchronism with an output changeover signal STB, numeral 26 indicates a gray scale voltage generating part which generates scale voltages of n-powers of 2 from the modulation circuit reference voltages V0 to VM which the display controller 8 outputs based on resistance division, numeral 22 indicates a decoder which selects a voltage from the gray scale voltages of n-power of 2 corresponding to display data of n bits which the data latch 23 outputs, and numeral 21 indicates an output circuit which is constituted of voltage followers for outputting an output of the decoder 22 as output voltages Y1 to Ym to respective longitudinal lines 1 of the display panel 4.

Further, Symbol HR/L indicates a signal for determining the shift direction of the shift register 25 and is fixed to the logic circuit voltage Vcc or a ground voltage GND. Here, the modulation circuit reference voltages V0 to VM are the voltages which are generated by equally dividing the gap between the non-light-emitting voltage VEH and the maximum light emitting voltage VEL into M portions, wherein the divided resistance values of the resistance which constitutes the gray scale voltage generating part 26 are all equal and the linear relationship is established between the gray scales and the output voltage.

Here, when one horizontal scanning period is started, the inside of the shift register 25 into which the start pulse HIO is inputted as the signal HI01 (or HI02) of the first data driver is shifted in synchronism with the horizontal clock HCLK, while when the latch signal is outputted, the display data of n bits is sequentially fetched into the data register 24 simultaneously with respect to three outputs.

When the fetching of display data into the data register 24 of the first data driver is finished, the voltage of HI02 (or HI01) becomes the logic circuit voltage Vcc. The voltage Vcc is inputted to the signal HI01 (or HI02) of the second data driver and the fetching of the display data into the second data driver is started.

When the fetching of all display data into the data register 24 is finished in this manner, immediately before one horizontal scanning period, all display data is fetched into the data latch 23 from the data register 24 in synchronism with the building up of the output change over signal STB. The fetched data is converted into the gray scale voltages respectively by the decoder 22 and the gray scale voltages are outputted to the respective longitudinal lines by the output circuit 21.

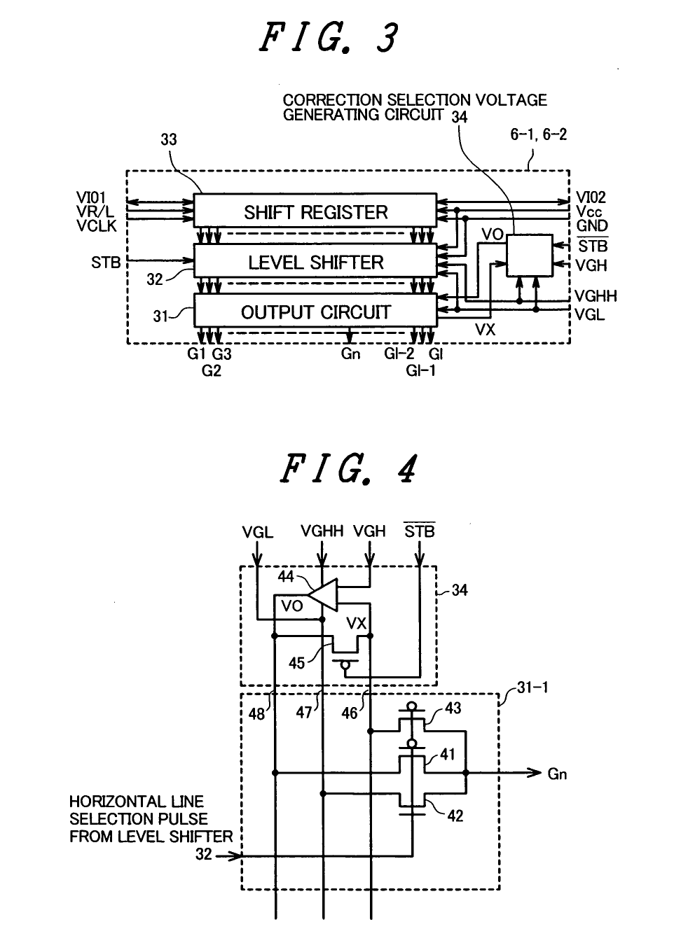

FIG. 3 is a constitutional view of a scanning driver which constitutes the scanning circuits 6-1, 6-2 shown in FIG. 1. The scanning circuits are constituted of the scanning drivers connected in series.

In FIG. 3, numeral 33 indicates a shift register which generates a selection signal for sequentially changing over the selected horizontal lines for every one horizontal scanning period, numeral 32 indicates a level shifter which converts an output from the shift register 33 from a level of a logic circuit voltage Vcc-GND to a level of high power source voltage VGHH-non-selection voltage VGL, numeral 31 indicates an output circuit which is constituted of a CMOS inversion circuit for outputting the selection voltage VGH or the non-selection voltage VGL as the output voltages G1 to GI to the respective horizontal lines 2 of the display panel 4 in response to the level-shifted output of the shift register 33, and numeral 34 indicates a correction selection voltage generating circuit which generates a correction selection voltage V0 to be inputted to the output circuit 31. Symbol VR/L indicates a signal for determining the shift direction of the shift register and is fixed to the logic circuit voltage Vcc or the ground voltage GND.

Here, when one vertical scanning period is started, the start pulse VIO is inputted as the VIO1 (or VI02) signal of the first scanning driver, and the inside of the shift register 33 is shifted in synchronism with the vertical clock VCLK for every one horizontal scanning period and the selection signal is sequentially outputted.

Next, a logic product of the outputted selection signal and the inversion signal of the output changeover signal STB has a level thereof shifted to the high power source voltage VGHH—non-selection voltage VGL by the level shifter 32, and the corrected selection voltage V0 which is generated by the corrected selection voltage generating circuit 34 is inputted to the output circuit 31 and then is outputted to the selected horizontal line wiring of the display panel 4 as a selected voltage VGH. On the other hand, the non-selection voltage VGL is outputted to the non-selected horizontal lines of the display panel 4.

When the shift inside the first scanning driver is finished, the voltage of the VIO2 (or VI01) becomes the logic circuit voltage Vcc, the voltage of the signal VI02 (or VI01) is inputted to the signal VIO1 (or VIO2) of the second scanning driver, and the shift in the inside of the second scanning driver is started.

In this manner, all horizontal lines are sequentially selected. The corrected selection voltage generating circuit 34 of the respective scanning drivers becomes operable when VIO1 (or VIO2) is inputted therein and stops the operation when VIO2 (or VIO1) is inputted to the next scanning driver.

FIG. 4 shows the detail of the output circuit 31 and the correction selection voltage generating circuit 34 in the inside of the scanning driver shown in FIG. 3. Numeral 31-1 indicates a unit of the output circuit which is provided for every horizontal line.

In FIG. 4, numeral 41 indicates a selection switch (pMOS) 42 which turns on and off a correction selection voltage V0 which the correction selection voltage generating circuit 34 generates, numeral 42 indicates a non-selection switch (nMOS) which turns on and off a non-selection voltage VGL, and numeral 43 indicates a detection switch (pMOS) which transmits an output voltage Gn of the output circuit of the selected horizontal line as an input voltage VX to the correction selection voltage generating circuit 34.

Further, numeral 44 indicates a differential amplifier which outputs the correction selection voltage V0 such that the input voltage VX from the output circuit unit 31-1 does not flow in the horizontal line and the correction is not performed, numeral 45 indicates a feedback switch (PMOS) which is turned on and off in response to an inversion signal of an output changeover signal STB, numeral 46 indicates a correction selection voltage generating circuit input line which connects the detection switch 43 (pMOS) in the inside of each output circuit unit 31-1 and the input of the differential amplifier 44 in the inside of the correction selection voltage generating circuit 34, numeral 47 indicates a power source line which supplies the non-selection voltage VGL to the non-selection switch 42 (nMOS) in the inside of the output circuit unit 31-1, numeral 48 indicates a correction selection voltage generating circuit output line which connects the selection switch 41 (PMOS) in the inside of each output circuit unit 31-1 and the output of the differential amplifier 44 in the inside of the correction selection voltage generating circuit 34.

Here, when the output changeover signal STB falls and an inversion signal thereof rises, the pMOS feedback switch 45 is turned off and, at the same time, a low-voltage horizontal line selection pulse is outputted to the selected horizontal line from the level shifter 32 and hence, the nMOS non-selection switch 42 of the selected horizontal line is turned off, and the pMOS selection switch 41 and the pMOS detection switch 43 are turned on, and the output voltage Gn of the output circuit rises from the non-selection voltage VGL to the selection voltage VGH.

In a steady state, the differential amplifier 44 outputs the correction selection voltage V0 such that the input voltage VX from the output circuit unit 31-1 becomes equal to the horizontal line selection voltage VGH when the electric current does not flow in the horizontal line and the correction is not performed.

Here, since the electric current does not flow into the pMOS detection switch 43 and hence, the output voltage Gn of the output circuit unit 31-1 becomes equal to the input voltage VX. That is, the output voltage Gn of the output circuit unit 31-1 is always set equal to the horizontal line selection voltage VGH.

Next, when the output changeover signal STB rises and the inversion signal falls, the pMOS feedback switch 45 is turned on and, at the same time, the horizontal line selection pulse of the selected horizontal line assumes a high voltage and hence, the PMOS selection switch 41 of the selected horizontal line and the pMOS detection switch 43 are turned off and the nMOS non-selection switch 42 is turned on whereby the output voltage Gn of the output circuit unit 31-1 is lowered from the selection voltage VGH to the non-selection voltage VGL.

Here, the pMOS feedback switch 45 is turned on during the non-selection period in which the pMOS selection switch 41 and the pMOS detection switch 43 are turned off. As a result, it is possible to prevent a phenomenon that the feedback path is disconnected and the output of the differential amplifier 44 becomes unstable when the selected horizontal line is changed over.

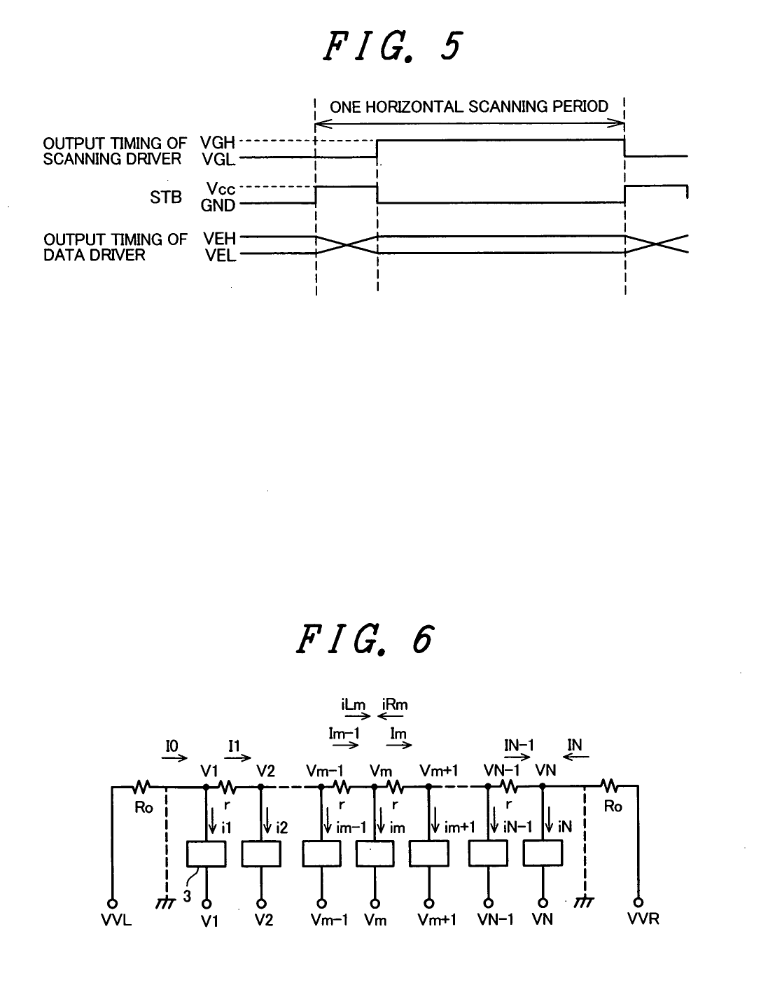

FIG. 5 shows the output timing of the data driver and the scanning driver within one horizontal scanning period.

In FIG. 5, in synchronism with the rising of the output changeover signal STB, the output of the data driver is changed over. After a lapse of the data driver output delay time which is determined based on the resistance and the capacitance of the longitudinal line and the output impedance of the data driver, the output of the selected horizontal line scanning driver is changed from the non-selection voltage VGL to the selection voltage VGH in synchronism with the falling of the output changeover signal STB.

At a point of time that the one horizontal scanning period is finished, the output of the selected horizontal line scanning driver is changed from the selection voltage VGH to the non-selection voltage VGL and, at the same time, the output of the data driver is changed. When the electric current flows in the horizontal line, to prevent the voltage drop, the horizontal line resistance is set to a low value and a horizontal line time constant is small compared to a longitudinal line constant.

In the timing of this embodiment, the light emitting time is determined based on the output time of the scanning driver which outputs the signal to the horizontal line having the small line time constant. As a result, it is possible to decrease the non-uniformity of the brightness attributed to the line delay.

In this embodiment, the selection voltage which is inputted to the left and right scanning driver output circuit is corrected such that the voltage drop at the scanning driver output points at the time of selection becomes zero respectively without depending on the display data and hence, the voltage of the scanning driver output points always assumes the fixed selection voltage VGH.

FIG. 6 is a view for explaining the voltage drop of the horizontal line and the correction value of the data driver output voltage correction value.

In FIG. 6, numeral 3 indicates MIM type electron emission elements, symbol r indicates the scanning line resistance per one pixel, symbol Ro indicates the ON resistance of the scanning driver output circuit, symbol im indicates a diode current of the mth pixel, symbol iRm indicates a component of the diode current im of the mth pixel which flows in from right, symbol iLm indicates a component of the diode current im of the mth pixel which flows in from left, symbol Vm indicates a horizontal line voltage drop which is generated in the mth pixel, symbol Im indicates an electric current which flows into the (m+1)th pixel from the mth pixel. Symbol VVL is a selection voltage correction value which is inputted to the scanning driver output circuit on the left end and symbol VVR is a correction selection voltage which is inputted to the scanning driver output circuit on the right end.

To set the diode current im which flows in the respective pixels of the MIM type electron emission elements 3 to a given value, to the output of the data driver outputted to the mth pixel, the voltage which is corrected by the horizontal line voltage drop Vm generated in the mth pixel is outputted and the corrected voltages which are corrected by the values VVL and VVR are inputted respectively to the output circuit of the left and right scanning drivers so that the voltage drop becomes zero at the output points of the scanning drivers.

The horizontal line voltage drop Vm generated in the mth pixel is obtained as follows. By inputting corrected values VVL and VVR respectively to the scanning driver output circuits, the amount of voltage drop at the output points of the scanning drivers become zero and hence, the left and right output points of the scanning drivers become the virtual ground points.

The diode current im of the mth pixel is constituted of two components, that is, iLm and iRm which flow in the pixel from the scanning circuits on both sides. Assuming the voltage drop generated in the mth pixel as vm when the diode current flows in only the mth pixel, since the voltage drops to the ground points at both ends are equal, a following formula (1) is established.

Formula (1)
vm=−(m−1)riLm=−(N−m)riRm (1)

The component iLm of the diode current im is obtained by a following formula (2) by taking iRm=im−iLm into consideration.

$$Formula ( 2 ) \\ iLm = \frac{N - m}{ N - 1} im \qquad \begin{matrix} \\ ( 2 )\end{matrix}$$

Further, the component iRm of the diode current im is obtained by a following formula (3).

$$Formula ( 3 ) \\ iRm = \frac{m - 1}{N - 1} im \qquad \begin{matrix} \\ ( 3 )\end{matrix}$$

As expressed by the following formula (4) based on the principle of the superposition, the electric current IN which flows in the Nth pixel at the right end from the ground point is expressed by a sum of the components iRm of the diode current im of the mth pixel which flow in the pixel from the right.

$$Formula ( 4 ) \\ IN = {\sum }_{j = 1}^{N} iRj = {\sum }_{j = 1}^{N} \frac{j - 1}{N - 1} ij \qquad \begin{matrix} \\ ( 4 )\end{matrix}$$

Since the electric current is preserved, the electric current Im-1 which flows in the mth pixel from the (m−1)th pixel is obtained by adding the diode current im of the mth pixel to the electric current Im which flows in the (m+1)th pixel from the mth pixel. This relationship is established to the arbitrary m and the following formula (5) is established in consideration that the direction of IN is reverse of the other currents.

$$Formula ( 5 ) \begin{matrix}Im - 1 = Im + im \\ Im - 1 = - IN + {\sum }_{j = m}^{N} ij & ( 5 )\end{matrix}$$

Further, the voltage drop Vm−1 which is generated in the (m−1)th pixel is obtained by adding the voltage drop between the neighboring pixels to the Vm wherein the voltage drop is obtained by multiplying the resistance value r per one pixel to the electric current Im−1. This relationship is established to the arbitrary m in consideration that the voltage drop VN on the Nth pixel is always zero and hence, a following formula (6) is established.

$$Formula ( 6 ) \\ V m - 1 = Vm + rIm - 1 \\ Vm - 1 = r {\sum }_{j = m}^{N} I j - 1 \qquad \begin{matrix} \\ ( 6 )\end{matrix}$$

From the above, by sequentially calculating the formulae (5) (6) using IN as an initial value in the formula (4), it is possible to calculate the voltage drop generated in the mth pixel. In order to allow the given diode current, the data driver output voltage is corrected only by this value.

FIG. 7 shows the detail of a voltage drop correction circuit (1). The voltage drop correction circuit (1) is incorporated in the inside of the display controller 8 shown in FIG. 1 and outputs the 3-output display data of n bits D0, D1, D2 to the modulation circuit 5. Other portions of the display controller 8 receive video signals from the outside of the display device and output corrected 3-output display data of n bits D0, D1, D2 corresponding to red, green, blue to the voltage drop correction circuit (1), and control signals are outputted to the modulation circuit 5 and the scanning circuits 6-1, 6-2.

In FIG. 7, numeral 71 indicates an inverse gamma processing part, numeral 72 indicates a parallel/serial (P/S) converting circuit which converts the display data D0, D1, D2 corresponding to red, green, blue in conformity with the arrangement on the display panel 4, numeral 73 indicates a line memory which holds the display data which is converted into the serial data, numeral 74 indicates an adding circuit for adding the correction data to the display data, numeral 75 indicates a serial/parallel (S/P) converting circuit for converting the corrected display data into the display data D0, D1, D2 corresponding to red, green, blue.

Further, numeral 76 indicates a data/current (D/C) converting circuit formed of a conversion table which converts the display data into the diode current, numerals 78-1 to 78-7 indicate correction voltage calculation means for calculating the correction voltages, and numeral 77 indicates a voltage/data (V/D) converting circuit for converting the correction voltage to the correction data.

Further, numeral 78-1 indicates a line memory which holds the diode current value ij of each pixel, numeral 78-2 indicates an IN calculating circuit which calculates an electric current IN which flows from the ground point to the Nth pixel at the right end expressed by the formula (4) by multiplying the diode current values ij and coefficients of the respective pixels and by sequentially adding the multiplication values, numeral 78-3 indicates an electric current IN latch circuit which holds the calculated electric current IN, numeral 78-4 indicates a current ij adding circuit which subsequently adds the diode current ij of the respective pixels among the line memory 78-1 from the Nth pixel, 78-5 indicates an electric current Im−1 calculating circuit which obtains an electric current Im−1 which flows from the (m−1)th pixel to the mth pixel expressed by the formula (5) by subtracting the electric current IN held in the electric current IN latch circuit 78-3 from the added value of the electric current ij adding circuit 78-4, 78-6 indicates current Ij adding circuit which sequentially adds the electric currents Ij from the Nth pixel, 78-7 indicates a Vm−1 calculating circuit which obtains the voltage drop Vm−1 generated in the (m−1)th pixel shown in the formula (6) by adding a value which is obtained by multiplying the scanning line resistance r per one pixel to the added value from the electric current Ij adding circuit 78-6.

The 3-output display data of n bits D0, D1, D2 which correspond to red, green, blue and are inputted to the voltage drop correction circuit (1) shown in FIG. 7 are, after being subjected to the inverse gamma correction based on the relationship between the drive voltage and the light emitting characteristic of the display panel 4 in the inverse gamma processing part 71, converted into the serial data which conforms to the arrangement on the display panel 4 by the parallel/serial converting circuit 72, and is sequentially written in the line memory 73.

In parallel with such an operation, the converted serial data is inputted to the data current conversion part 76 and, after being converted into the diode current ij, the serial data is inputted to the correction voltage calculation means which consists of 78-1 to 78-7 and the correction voltages are calculated. Here, the diode currents ij are sequentially held in the line memory 78-1.

On the other hand, in the IN calculating circuit 78-2, the electric current IN which flows in the Nth pixel from the ground point which is expressed by the formula (4) is calculated by sequentially adding the multiplication of the diode current ij and the coefficient to the added value up to the preceding pixel, and a value at a point of time that the sum of the Nth pixel is finished is held in the electric current IN latch 78-3.

In the next horizontal period, in synchronism with sequential reading of the display data from the Nth pixel by the line memory 73, the voltage drop for correction is read out and the voltage drop for correction is added. The voltage drop Vm−1 generated in the (m−1)th pixel is calculated in the following manner.

The mth diode current im is read out from the line memory 78-1 and the electric current im is added to the sum of the diode currents from the Nth pixel to the (m−1)th pixel held in the inside of the electric current ij adding circuit 78-4.

From this added value, the electric current IN held in the electric current IN latch circuit 78-3 is reduced in the current Im−1 calculating circuit 78-5, thus calculating the electric current Im−1 which flows into the mth pixel from the (m−1)th pixel expressed by the formula (5).

The electric current Im−1 is added to the sum of current from the electric current −IN−1 which flows from the (N−1)th pixel to the Nth pixel at the right end to the electric current Im which flows from the mth pixel to the (m+1)th pixel held in the inside of the electric current Ij adding circuit 78-6.

The added value is multiplied with the scanning line resistance r per one pixel in the Vm−1 calculating circuit 78-7, the voltage drop Vm−1 generated in the (m−1)th pixel expressed by the formula (6) is obtained.

The voltage drop Vm−1 is converted into the correction data by the voltage data converting circuit 77 and the correction data is added to the display data held in the line memory 73 by the adding circuit 74. Thereafter, the corrected display data is converted into the display data D0, D1, D2 corresponding to red, green, blue by the serial/parallel converting circuit 75.

In this embodiment, the output voltage Gn of the output circuit 31 of the scanning driver is transmitted to the input of the differential amplifier 44 by way of the pMOS detection switch 43 and the input line 46 to the correction selection voltage generating circuit 34, and is compared with the horizontal line selection voltage VGH when the correction is not performed by the differential amplifier 44 and hence, the output of the differential amplifier 44 is corrected and is outputted to the pMOS selection switch 41 by way of the output line 48.

Due to the high input impedance of the differential amplifier 44, the steady-state electric current does not flow into the input line 46 and the detection switch 43 and hence, the first input voltage of the differential amplifier 44 becomes equal to the scanning circuit output point voltage.

As a result, without depending on an amount of voltage drop which is generated by the electric current which flows in the horizontal line and the resistance of the output line 48 and the PMOS selection switch 41, the output voltage of the differential amplifier 44 is corrected such that the scanning circuit output point voltage becomes equal to the horizontal line selection voltage VGH when the correction is not performed. Accordingly, it is possible to correct the voltage drop which is generated by the electric current which flows in the horizontal line and the output ON resistance of the scanning circuit with high accuracy.

Further, a source voltage of the pMOS selection switch 41 is corrected by the output of the differential amplifier 44 and hence, it is possible to decrease a change of a gate-source voltage thus decreasing the ON resistance.

On the other hand, the PMOS feedback switch 45 is turned on during the non-selection period in which both of the pMOS selection switch 41 and the pMOS detection switch 43 are turned off. As a result, it is possible to prevent a phenomenon that when the selected horizontal line is changed over, the feedback path is disconnected and the output of the differential amplifier 44 becomes unstable.

### Embodiment 2

The above-mentioned embodiment 1 is directed to the case in which the overshooting is generated when the output voltage Gn of the output circuit rises from the non-selection voltage VGL to the selection voltage VGH and hence, the high accuracy control of the light emitting amount is difficult.

This overshooting is generated based on a phenomenon that the input voltage change is delayed with respect to the output voltage change of the differential amplifier 44 due to the delay attributed to the ON resistance of the pMOS selection switch 41 and the line capacitance of the horizontal line 2 or the delay attributed to the pMOS detection switch 43 and the line capacitance of the input line 46 of the differential amplifier 44.

In this embodiment, the OFF time of the pMOS feedback switch 45 is delayed than the ON time of the pMOS selection switch 41 and the pMOS detection switch 43 of the selected horizontal line.

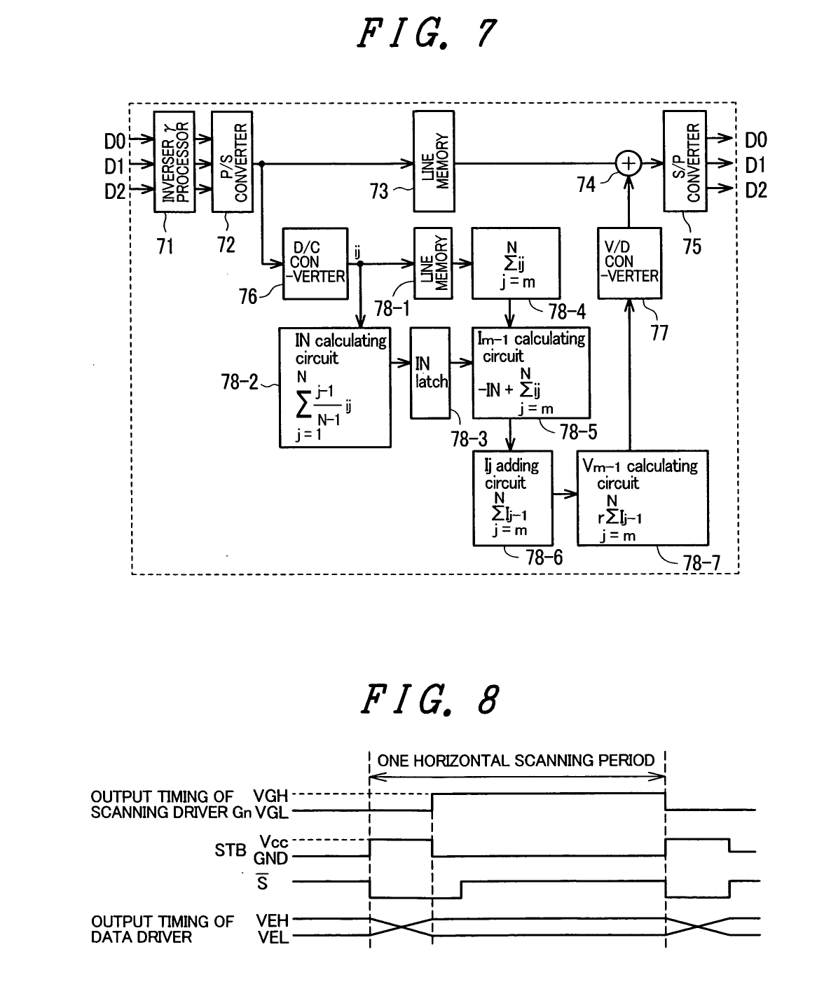

FIG. 8 shows the output timing of the data driver and the scanning driver during one horizontal scanning period. The output timing is substantially equal to the output timing shown in FIG. 5 except for the inversion signal of the signal S. The inversion signal of the signal S is a PMOS feedback switch control signal which is inputted to a gate of the pMOS feedback switch 45 in place of the inversion signal of the output changeover signal STB.

The manner of operation is explained in conjunction with FIG. 3 and FIG. 4. When the output changeover signal STB falls, the horizontal line selection pulse is outputted to the selected horizontal line from the level shifter 32, then MOS non-selection switch 42 of the selected horizontal line is turned off, the pMOS selection switch 41 and the pMOS detection switch 43 are turned on and hence, the output voltage Gn of the output circuit rises to the selection voltage VGH from the non-selection voltage VGL.

Here, the inversion signal of the signal S shown in FIG. 8 is a low-voltage signal and the pMOS feedback switch 45 is turned on and hence, the changes of the output voltage and the input voltage of the differential amplifier 44 are equal whereby the delay is not generated. Thereafter, when the output voltage Gn of the output circuit rises to the vicinity of the selection voltage VGH and, thereafter, the inversion signal of the signal S rises, the pMOS feedback switch 45 is turned off.

After this point of time, the although the input voltage change is delayed with respect to the output voltage change of the differential amplifier 44, the change of the output voltage of the differential amplifier 44 is small and hence, there is no possibility that the overshoot of the selection voltage output in horizontal line is generated.

In this embodiment, by delaying the OFF time of the pMOS feedback switch 45 than the ON times of the pMOS selection switch 41 and the pMOS detection switch 43, at the time of the initial sharp potential fluctuation which is generated when the output voltage of the scanning circuit rises to the selection voltage from the non-selection voltage, there is no possibility that the input voltage change is delayed than the output voltage of the differential amplifier 44 and hence, it is possible to reduce overshoot of the selection voltage output in horizontal line.

This invention is not to have limited to the display panel by which it provided with the emission element. This invention can be used for the display panel which has a plurality of horizontal line wirings and a plurality of longitudinal line wirings (ex. JP-A-57-67993, which disclose Liquid crystal display). This invention, because the correction selection voltage is higher than the selection voltage when the output voltage of the scanning circuit rises from non-selection voltage to the selection voltage, can shorten the time constant of the rise.

### Embodiment 3

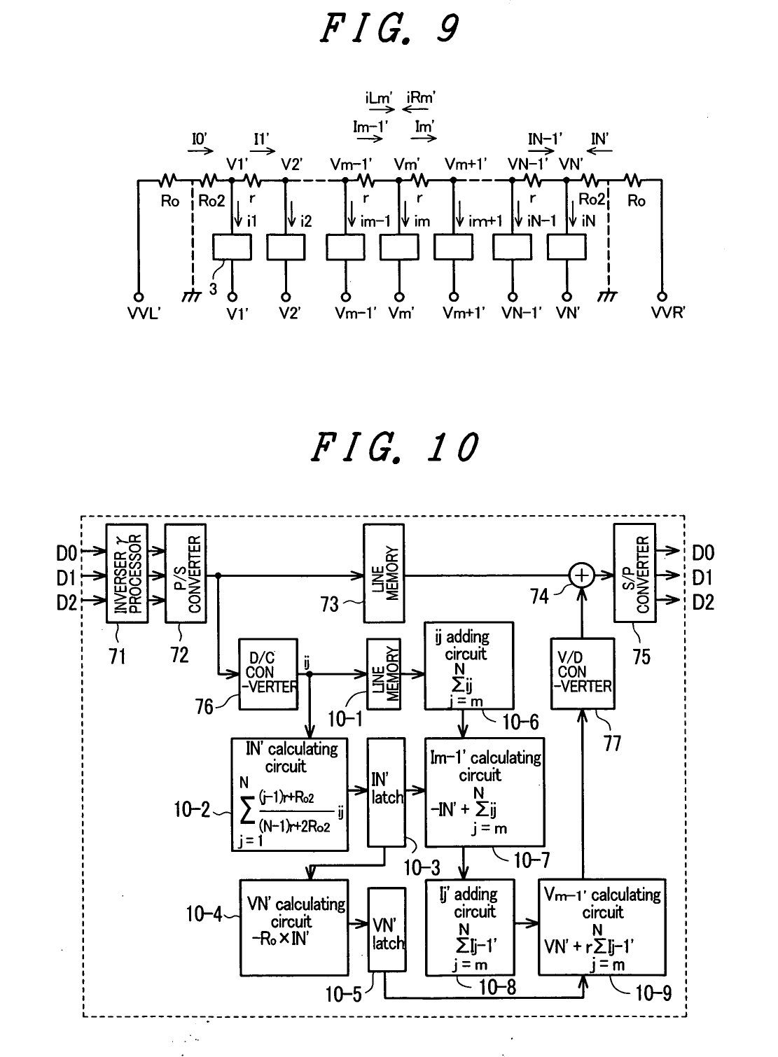

In this embodiment, the data driver output voltage is corrected by taking the resistance Ro2 to pixels at both ends from the output point of the scanning driver into consideration in Embodiment 2. FIG. 9 is a view for explaining the horizontal line voltage drop and the manner of correction at such a point of time.

In FIG. 9, symbols 3, r, Ro, im are substantially equal to the corresponding symbols shown in FIG. 6, while symbols iRm′, iLm′, Vm′, Im′, VVL′, VVR′ are substantially equal to the corresponding symbols iRm, iLm, Vm, Im, VVL, VVR shown in FIG. 6. Further, symbol Ro2 indicates the resistance from the scanning driver output point to the pixels at both ends.

The horizontal line voltage drop Vm′ generated in the mth pixel is obtained as follows. By inputting corrected values VVL′ and VVR′ respectively to the scanning driver output circuits, the amount of voltage drop at the output points of the scanning drivers become zero and hence, the left and right output points of the scanning drivers become the virtual ground points.

The diode current im of the mth pixel is constituted of two components, that is, iLm′ and iRm′ which flow in the pixel from the scanning circuits from both sides. Assuming the voltage drop generated in the mth pixel as vm′ when the diode current flows in only the mth pixel, since the voltage drops to the ground points at both ends are equal, a following formula (7) is established.

Formula (7)
vm′=−{(m−1)r+Ro2}iLm′=−{(N−m)r+Ro2}iRm′ (7)

The component iLm′ of the diode current im is obtained by a following formula (8) by taking iRm′=im−iLm′ into consideration.

$$Formula ( 8 ) \\ {iLm}^{′} = \frac{( N - m ) r + Ro 2}{( N - 1 ) r + 2 Ro 2} im \qquad \begin{matrix} \\ ( 8 )\end{matrix}$$

Further, the component iRm′ of the diode current im is obtained by a following formula (9).

$$Formula ( 9 ) \\ {iRm}^{′} = \frac{( m - 1 ) r + Ro 2}{( N - 1 ) r + 2 Ro 2} im \qquad \begin{matrix} \\ ( 9 )\end{matrix}$$

As expressed by the following formula (10) based on the principle of the superposition, the electric current IN′ which flows in the Nth pixel at the right end from the ground point is a sum of the components iRm′ of the diode current im of the mth pixel which flow in the pixel from the right end.

$$Formula ( 10 ) \\ {IN}^{ ′} = {\sum }_{j = 1}^{N} {iRj}^{′} = {\sum }_{j = 1}^{N} \frac{( j - 1 ) r + Ro 2}{( N - 1 ) r + 2 Ro 2} ij \qquad \begin{matrix} \\ ( 10 )\end{matrix}$$

By multiplying the resistance Ro2 from the scan driver output point to the pixels at both ends to IN′, it is possible to obtain the voltage drop VN′ at the Nth pixel using a following formula (11).

Formula (11)
VN′=−Ro2×IN′ (11)

Further, since the electric current is preserved, the electric current Im−1′ which flows from the (m−1)th pixel to the mth pixel is obtained by adding the diode current im of the mth pixel to the electric current Im′ which flows from the mth pixel to the (m+1) pixel.

This relationship is established to an arbitrary m, and in consideration that the direction of IN′ is opposite to others, a following formula (12) is established.

$$Formula ( 12 ) \begin{matrix}Im - {1}^{′} = {Im}^{′} + im \\ Im - {1}^{′} = - {IN}^{ ′} + {\sum }_{j = m}^{N} ij & ( 12 )\end{matrix}$$

Further, the voltage drop Vm−1′ which is generated in the (m−1)th pixel is a value which is obtained by adding the voltage drop between the neighboring pixels, wherein the voltage drop Vm−1′ is obtained by multiplying the resistance value r per one pixel from the electric current Vm′ to the electric current Im−1′.

This relationship is established to the arbitrary m and the following formula (13) is established in consideration that the voltage drop at the Nth pixel is VN′.

$$Formula ( 13 ) \\ V m - {1}^{′} = {Vm}^{′} + rIm - {1}^{′} \\ Vm - {1}^{′} = {VN}^{ ′} + r {\sum }_{j = m}^{N} I j - {1}^{′} \qquad \begin{matrix} \\ ( 13 )\end{matrix}$$

From the above, by sequentially calculating the formulae (12) (13) using IN′, VN′ as initial values in the formulae (10) (11), it is possible to calculate the voltage drop Vm′ generated in the mth pixel. In order to allow the given diode current to flow in the pixel, the data driver output voltage is corrected only by this value.

FIG. 10 shows the detail of a voltage drop correction circuit (2). The voltage drop correction circuit (2) is incorporated in the inside of the display controller 8 shown in FIG. 1 and outputs the 3-output display data of n bits D0, D1, D2 to the modulation circuit 5.

Other portions of the display controller 8 receive video signals from the outside of the display device and output 3-output display data of n bits D0, D1, D2 corresponding to red, green, blue to the voltage drop correction circuit (2), and control signals are outputted to the modulation circuit 5 and the scanning circuits 6-1, 6-2.

In FIG. 10, symbols 71, 72, 73, 74, 75, 76, 77 indicate parts identical with the parts shown in FIG. 7 and numerals 10-1 to 10-9 indicate correction voltage calculation means which calculates the correction voltage.

Further, numerals 10-1, 10-3, 10-6, 10-7, 10-8 are respectively indicate 78-1, 78-3, 78-4, 78-5, 78-6 in FIG. 7, wherein numerals 10-2 and 10-4 indicate an IN′ calculating circuit which calculates an electric current IN′ which flows from the ground point to the Nth pixel at the right end expressed by the formula (10) by multiplying the diode current values ij of the respective pixels and the coefficient and by sequentially adding the multiplied values and a VN′ calculating circuit which calculates an electric current VN′ in the Nth pixel expressed in the formula (11) by multiplying the electric current IN′ and the coefficient, numeral 10-5 indicates a voltage drop VN′ latch circuit which holds the calculated voltage drop VN′, numeral 10-9 indicates a Vm−1′ calculating circuit which obtains the voltage drop Vm−1′ generated in the (m−1)th pixel shown in the formula (13) by adding a value which is obtained by multiplying the scanning line resistance r per one pixel to the added value from the electric current Ij adding circuit 10-8 to the voltage drop VN′ held in the latch circuit 10-5.

In the voltage drop correction circuit (2) shown in FIG. 10, the correction of display data is performed in the same manner as the voltage drop correction circuit (1) shown in FIG. 7.

The 3-output display data of n bits D0, D1, D2 which correspond to red, green, blue and are inputted to the voltage drop correction circuit (2) shown in FIG. 10 are, after being subjected to the inverse gamma correction based on the relationship between the drive voltage and the light emitting characteristic of the display panel 4 in the inverse gamma processing part 71, converted into the serial data which conforms to the arrangement on the display panel 4 by the parallel/serial converting circuit 72, and is sequentially written in the line memory 73.

Concurrently, the converted serial data is inputted to the data current conversion part 76 and the data is converted to a diode current ij and then inputted to the correction voltage calculation means 10-1 to 10-9, wherein the voltage drop Vm−1 calculated by the formula (13) is converted to the corrected data 77 in the voltage data converting circuit 77 and in the adding circuit 74, the converted data is added to the display data held in the line memory 73.

Thereafter, the corrected display data is converted into the display data D0, D1, D2 corresponding to red, green, blue by the serial/parallel converting circuit 75.

In this embodiment, the output voltage of the data driver is corrected by taking the resistance Ro2 from the output point to the pixels on the both ends of the scanning driver into consideration, the higher-accuracy correction can be performed.

### Embodiment 4

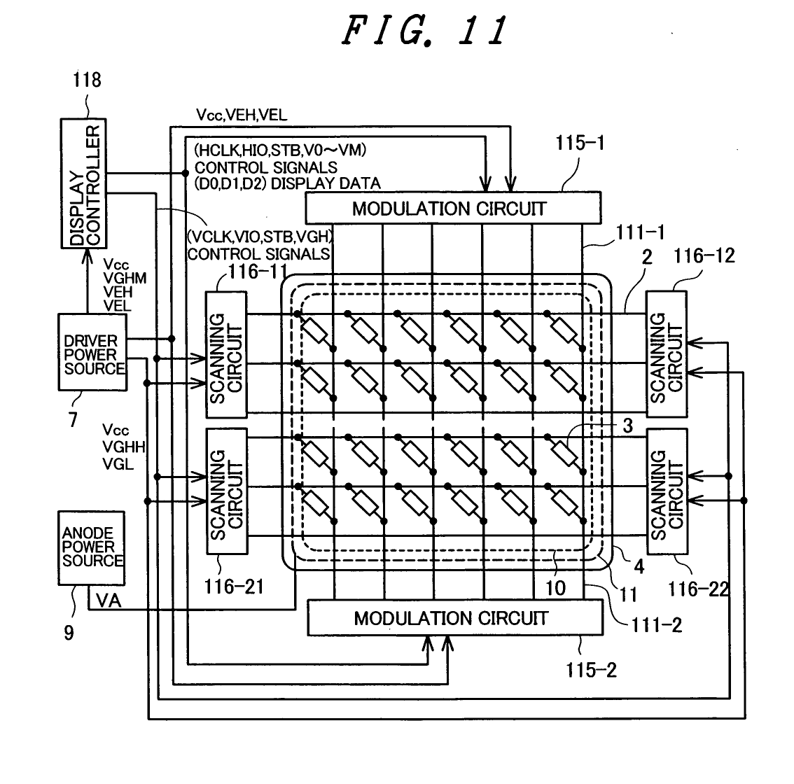

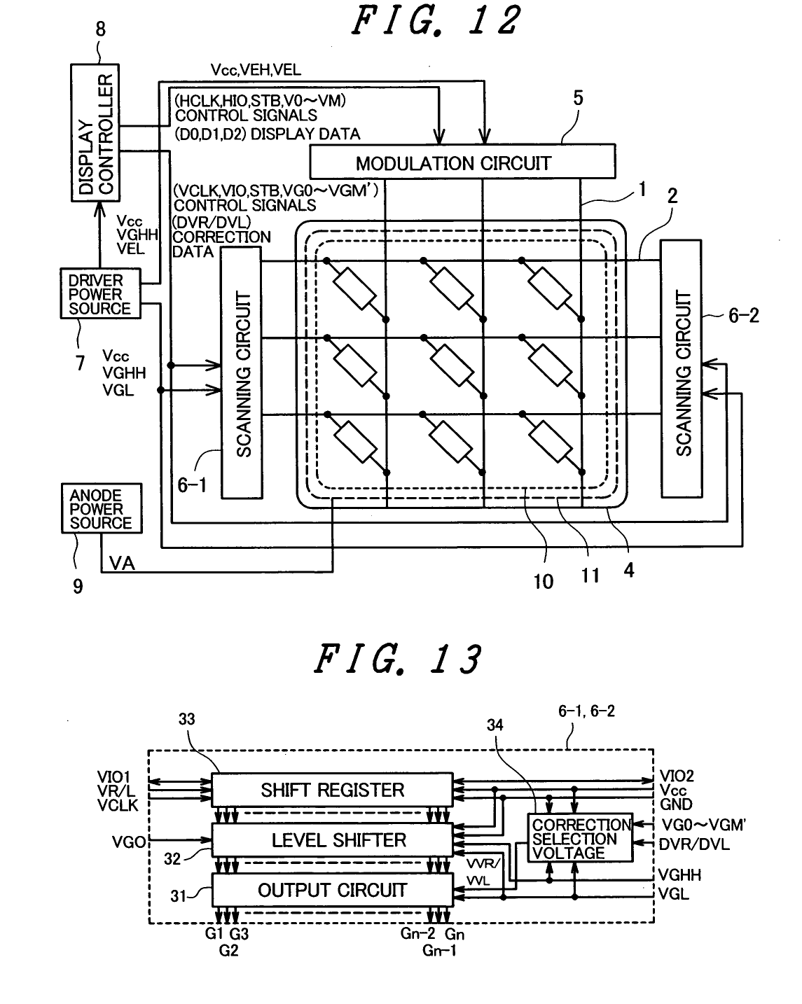

FIG. 11 is another whole constitutional view (2) according to the invention, wherein the screen is divided into upper and lower blocks and images are simultaneously displayed on the upper and lower blocks.

In FIG. 11, symbols 2, 4, 7, 9, 10, 11 indicate parts identical with the parts shown in FIG. 1 and numerals 111-1, 111-2 indicate longitudinal lines which are divided at the center of the display panel 4, numerals 115-1, 115-2 indicate modulation circuits which respectively output modulation signals to the upper and lower longitudinal lines respectively, numerals 116-11, 116-12 indicate scanning circuits which are arranged on both sides of the display panel 4 and perform the horizontal line selection of the upper portion of the screen, and numerals 116-21, 116-22 indicate scanning circuits which are arranged on both sides of the display panel 4 and perform the horizontal line selection of the lower portion of the screen.

Further, the driver power source 7 supplies a high supply voltage VGHH, a non-selection voltage VGL and a logic circuit voltage Vcc to the scanning circuits 116-11, 116-12, 116-21, 116-22. Further, the driver power source 7 supplies a maximum light emitting voltage VEL, a non-light emitting voltage VEH, a high supply voltage VGHM and a logic circuit voltage Vcc to the modulation circuits 115-1, 115-2 and the display controller 118.

Further, the display controller 118 outputs a vertical clock VCLK, a start pulse VIO, a output changeover signal STB to the scanning circuits 116-11, 116-12, 116-21, 116-22, and outputs a horizontal clock HCLK, a start pulse HIO, an output changeover signal STB, the 3-output display data D0, D1, D2 of nbits corresponding to red, green, blue, n-bit and reference voltages V0 to VM to the modulation circuits 115-1, 115-2.

Among these control signals, all signals except for the reference voltages V0 to VM have an amplitude of the logic circuit voltage Vcc. Here, corresponding to red, green, blue, 3-output display data D0, D1, D2 of n bits which differ from each other between the modulation circuits 115-1, 115-2 are inputted.

The constitution and the manner of operation of the modulation circuits 115-1, 115-2 and the constitution and the manner of operation of the scanning circuits 116-11, 116-12, 116-21, 116-22 in FIG. 11 are equal to those constitution and the manner of operation of the first embodiment.

Two voltage drop correction circuits shown in FIG. 7 or FIG. 10 are provided in the inside of the display controller 118, wherein the inputted 3-output display data D0, D1, D2 of n bits are simultaneously outputted to the respective modulation circuits 115-1, 115-2. A frame memory is mounted in another portion of the display controller 118, receives the video signals from the outside of the display device, and outputs the 3-output display data D0, D1, D2 of n bits corresponding to red, green, blue to the voltage drop correction circuit corresponding to the upper and lower blocks. Further, the control signals are outputted to the modulation circuits 115-1, 115-2 and the scanning circuits 116-1, 116-2.

In this embodiment, the screen is divided into the upper and lower blocks and the image is simultaneously displayed on the upper and lower blocks. As a result, the display time for one horizontal line can be increased twice compared to the related art. Accordingly, assuming that the brightness is equal, the electric current which flows in the horizontal line can be halved and the voltage drop amount to be corrected can be halved.

Further, since the longitudinal lines are divided, the drive capacities of the modulation circuits 115-1, 115-2 can be halved, and the power which is consumed by the modulation circuits 115-1, 115-2 can be halved.

In the embodiment 1 to the embodiment 4, the correction selection voltage generating circuit 34 is provided for every scanning driver. However, the correction selection voltage generating circuit 34 may be provided for every independently operating scanning circuit. That is, when the scanning circuits 6-1, 6-2 are arranged at both sides of the display panel 4 as shown in FIG. 1, the correction selection voltage generating circuit 34 maybe provided for every scanning circuit 6-1, 6-2.

Further, when the screen is divided into upper and lower blocks and images are simultaneously displayed on the upper and lower blocks as shown in FIG. 11, the correction selection voltage generating circuit may be provided for every scanning circuit 116-11, 116-12, 116-21, 116-22.

There may be a case that the resistance Ro2 to the pixels at both ends from the scanning driver output point differs for every horizontal line due to the line arrangement. In such a case, using Ro2 which differs for every horizontal line in the embodiment 3, a coefficient is calculated. Due to such a provision, it is possible to prevent the degradation of image qualities which is generated due to the irregularities of the resistance Ro2 to both-end pixels from the scanning driver output point.

### Embodiment 5

FIG. 12 is another overall constitutional view (3) according to the invention, wherein parts identical with the parts shown in FIG. 1 are given the same symbols.

The display panel 4 is formed of a back plate, a face plate and a side wall (not shown in the drawing). Phosphor films 10 are formed of films of three primary colors consisting of red, green and blue.

A modulation circuit 5 outputs a modulation signal to longitudinal lines 1. Scanning circuits 6-1, 6-2 are arranged at both sides of a display panel 4 and performs the horizontal line selection.

A driver power source 7 supplies a high supply voltage VGHH, a non-selection voltage VGL and a logic circuit voltage Vcc to scanning circuits 6-1, 6-2. Further, the driver power source 7 supplies a maximum light emitting voltage VEL, a non-light-emitting voltage VEH and a logic circuit voltage Vcc to the modulation circuit 5. Still further, the drive power source 7 supplies a maximum light emitting voltage VEL, a high supply voltage VGHH and a logic circuit voltage Vcc to the display controller 8.

The display controller 8 outputs a vertical clock VCLK, a start pulse VIO, a selection period signal VGO, scanning circuit reference voltages VGO to VGM′, scanning circuit voltage drop correction data DVR or DVL to the scanning circuits 6-1, 6-2. Further, the display controller 8 outputs a horizontal clock HCLK, a start pulse HIO, an output changeover signal STB, modulation circuit reference voltages V0 to VM, and 3-output display data D0, D1, D2 of n bits corresponding to red, green and blue to the modulation circuit 5.

These control signals and the correction data, except for the scanning circuit reference voltages VGO and VGM′ and the modulation circuit reference voltages VGO to VGM′, have an amplitude of the logic circuit voltage Vcc.

FIG. 13 is a constitutional view of a scanning driver which constitutes the scanning circuits 6-1, 6-2 shown in FIG. 12. The scanning circuits are constituted of the scanning drivers connected in series.

In FIG. 13, numeral 33 indicates a shift register which generates a selection signal for sequentially changing over the selected horizontal lines for every one horizontal scanning period, numeral 32 indicates a level shifter which converts an output from the shift register 33 from a level of a logic circuit voltage Vcc-GND to a level of high power source voltage VGHH—non-selection voltage VGL, numeral 31 indicates an output circuit which is constituted of a CMOS inversion circuit for outputting the selection voltage VGH or the non-selection voltage VGL as the output voltages G1 to Gn to the respective horizontal lines 2 of the display panel 4 in response to the level-shifted output of the level shifter 32, and numeral 34 indicates a correction selection voltage generating circuit which outputs a selection voltage which is corrected by VVR or VVL to the output circuit 31 based on bit scanning circuit voltage drop correction data DVR or DVL using the scanning circuit reference voltages VG0 to VGM′. Symbol VR/L indicates a signal for determining the shift direction of the shift register and is fixed to the logic circuit voltage Vcc or the ground voltage GND.

Here, when one vertical scanning period is started, the start pulse VIO is inputted as the VIO1 (or VI02) signal of the first scanning driver, and the inside of the shift register 33 is shifted in synchronism with the vertical clock VCLK for every one horizontal scanning period and the selection signal is sequentially outputted.

Next, a logic product of the outputted selection signal and the selection period signal VGO has a level thereof shifted to the high power source voltage VGHH—non-selection voltage VGL by the level shifter 32, and the selection voltage which is generated by the correction selection voltage generating circuit 34 based on the scanning circuit reference voltage VG0 to VGM′ and the m-bit scanning circuit voltage drop correction data DVR or DVL and is corrected by VVR or VVL is inputted to the output circuit 31 and then is outputted to the selected horizontal lines of the display panel 4 as a selected voltage VGH.

On the other hand, the non-selection voltage VGL is outputted to the non-selection horizontal lines of the display panel 4. When the shift inside the first scanning driver is finished, the voltage of the VIO2 (or VI01) becomes the logic circuit voltage Vcc, the voltage of the signal VI02 (or VI01) is inputted to the signal VIO1 (or VIO2) of the second scanning driver (not shown in the drawing), and the shift in the inside of the second scanning driver is started. In this manner, all horizontal lines are sequentially selected. The corrected selection voltage generating circuit 34 of the respective scanning drivers becomes operable when VIO1 (or VIO2) is inputted therein and stops operating when VIO2 (or VIO1) is inputted to the next scanning driver.

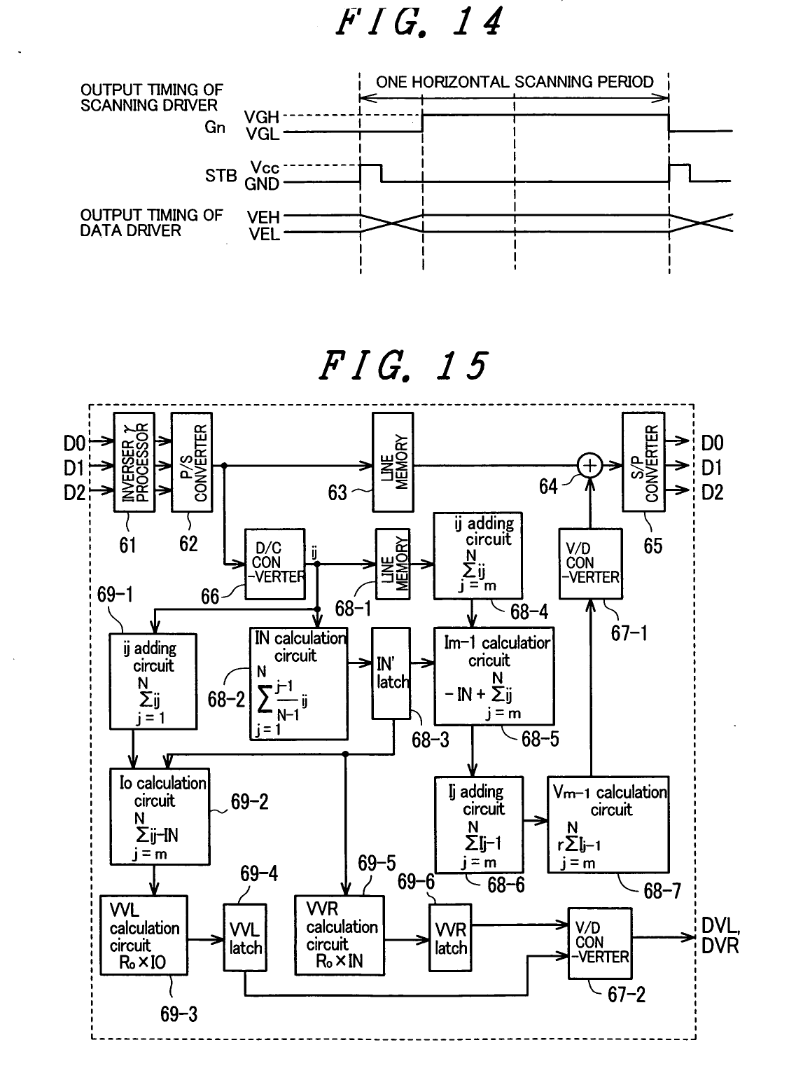

FIG. 14 shows the output timing of the data driver and the scanning driver within one horizontal scanning period. In FIG. 14, in synchronism with the rising of the output changeover signal STB, the output of the data driver is changed over. After a lapse of the data driver output delay time which is determined based on the resistance and the capacitance of the longitudinal lines and the output impedance of the data driver, the output of the selected horizontal line scanning driver is changed from the non-selection voltage VGL to the selection voltage VGH.

At a point of time that the one horizontal scanning period is finished, the output of the selected horizontal line scanning driver is changed from the selection voltage VGH to the non-selection voltage VGL and, at the same time, the output of the data driver is changed. When the electric current flows in the horizontal line, to prevent the voltage drop, the horizontal line resistance is set to a low value and a horizontal line time constant is small compared to a longitudinal line time constant.

In the timing of this embodiment, the light emitting time is determined based on the output time of the scanning driver which outputs the signal to the horizontal line having the small line time constant. As a result, it is possible to decrease the non-uniformity of the brightness attributed to the line delay.

In this embodiment, the selection voltage which is inputted to the left and right scanning driver output circuit is corrected such that the voltage drop at the scanning driver output points at the time of selection becomes zero respectively without depending on the display data and hence, the voltage of the scanning driver output points always assumes the fixed selection voltage VGH.

By sequentially calculating the formulae (5), (6) using IN indicated in the previously-mentioned formula (4) as an initial value, the voltage drop which is generated in the mth pixel can be calculated. To allow the flow of the predetermined diode current, it is sufficient to correct the data driver output voltage by this value. Further, since the electric current is stored, the electric currents IN, I0 respectively flow into the scanning driver ON resistance Ro. Accordingly, to use the output point of the scanning driver as virtual ground point, the correction values VVR, VVL of the selection voltage which are inputted to the scanning driver output circuits at the right end and the left end are expressed by following formulae (14), (15).

$$\begin{matrix}Formulae ( 14 ) & \\ VVR = Ro \times IN & ( 14 ) \\ Formulae ( 15 ) & \\ VVL = Ro \times I 0 = Ro ( {\sum }_{j = 1}^{N} Ij - 1 - IN ) & ( 15 )\end{matrix}$$

FIG. 15 shows the detail of a voltage drop correction circuit (3). The voltage drop correction circuit (3) is incorporated in the inside of the display controller 8 and outputs the 3-output display data of n bits D0, D1, D2 to the modulation circuit 5 and outputs the voltage drop correction data DVR, DVL to the scanning circuits 6-1, 6-2.

In FIG. 15, numeral 61 indicates an inverse gamma processing part, numeral 62 indicates a P/S (parallel/serial) converting circuit which converts the display data D0, D1, D2 corresponding to red, green, blue in conformity with the arrangement on the display panel 4, numeral 63 indicates a line memory which holds the display data which is converted into the serial data, numeral 64 indicates an adding circuit for adding the correction data to the display data, numeral 65 indicates a S/P (serial/parallel) converting circuit for converting the corrected display data into the display data D0, D1, D2 corresponding to red, green, blue.

Further, numeral 66 indicates a data/current converting circuit formed of a conversion table which converts the display data into the diode current, numerals 68-1 to 68-7 and 69-1 to 69-6 indicate correction voltage calculation means for calculating the correction voltages, and numeral 67-1 and 67-2 indicate voltage data converting circuits for converting the correction voltage to the correction data.

Further, numeral 68-1 indicates a line memory which holds the diode current value ij of each pixel, numeral 68-2 indicates an IN calculating circuit which calculates an electric current IN which flows from the ground point to the Nth pixel at the right end expressed by the formula (4) by multiplying the diode current values ij and coefficients of the respective pixels and by sequentially adding the multiplication values, numeral 68-3 indicates an electric current IN latch circuit which holds the calculated total current IN, numeral 68-4 indicates a current adding circuit which subsequently adds the diode current ij of the respective pixels among the line memory 68-1 from the Nth pixel, 68-5 indicates an electric current Im−1 calculating circuit which obtains an electric current Im−1 which flows from the (m−1)th pixel to the mth pixel expressed by the formula (5) by subtracting the total current IN held in the electric current IN latch circuit 68-3 from the added value of the electric current ij adding circuit 68-4, 68-6 indicates current Ij adding circuit which sequentially adds the electric currents Ij from the Nth pixel, 68-7 indicates a Vm−1 calculating circuit which obtains the voltage drop Vm−1 generated in the (m−1)th pixel shown in the formula (6) by adding a value which is obtained by multiplying the scanning line resistance r per one pixel to the added value from the electric current Ij adding circuit 68-6.

On the other hand, numeral 69-1 indicates an electric current ij adding circuit which adds the diode current values ij of the respective pixels up to Nth pixel, numeral 69-2 indicates an electric current I0 calculating circuit which subtracts the electric current IN held by the electric current IN latch circuit 69-1 from the value of the electric current ij adding circuit thus calculating the electric current I0 which flows toward the first pixel at the left end from the ground point, numeral 69-3 indicates a correction amount VVL calculating circuit which obtains an input voltage correction value VVL to a left-end scanning driver output circuit indicated in the formula (15) by multiplying the calculated electric currents I0 and coefficients, numeral 69-4 indicates a correction amount VVL latch circuit which holds the calculated correction amounts VVL, numeral 69-5 indicates a correction amount VVR calculating circuit which obtains an input voltage correction value VVR to a right-end scanning driver output circuit indicated in the formula (14) by multiplying the electric current IN held in the electric current IN latch circuit 68-3 and coefficients, and numeral 69-6 indicates a correction amount VVR latch circuit which holds the calculated correction amount VVR.

Hereinafter, the manner of operation is explained. The 3-output display data of n bits D0, D1, D2 which correspond to red, green, blue and are inputted to the voltage drop correction circuit (3) are, after being subjected to the inverse gamma correction based on the relationship between the drive voltage and the light emitting characteristic of the display panel 4 in the inverse gamma processing part 61, converted into the serial data which conforms to the arrangement on the display panel 4 by the parallel/serial converting circuit 62, and is sequentially written in the line memory 63. In parallel with such an operation, the serial data is inputted to the data current conversion part 66 and, after being converted into the diode current ij, the serial data is inputted to the correction voltage calculation means 68-1 to 68-7 and 69-1 to 69-6 and the correction voltages are calculated.

Here, the diode currents ij are sequentially held in the line memory 68-1. On the other hand, in the IN calculating circuit 68-2, the electric current IN which flows in the Nth pixel from the ground point which is expressed by the formula (4) by sequentially adding the multiplication of the diode current ij and the coefficient up to the preceding pixel is calculated, and a value at a point of time that the sum of the Nth pixel is finished is held in the electric current IN latch 68-3. On the other hand, the diode current values ij are sequentially added in the electric current ij adding circuit 69-1, and the electric current IN which is held by the electric current IN latch circuit 68-3 is subtracted from the value at a point of time that the addition of the Nth pixel is finished using the electric current I0 calculating circuit 69-2 thus calculating the electric current I0 which flows toward the first pixel at the left end from the ground point.

Further, in the correction amount VVL calculating circuit 69-3, the calculated electric current I0 and the coefficient are multiplied to each other thus obtaining the input voltage correction value VVL to the left-end scanning driver output circuit indicated in the formula (15), and the input voltage correction value VVL is held in the correction amount VVL latch circuit 69-4.

Further, in the correction amount VVR calculating circuit 69-5, the coefficient is multiplied to the electric current In held in the IN latch circuit 68-3 thus obtaining the input voltage correction value VVR to the right-end scanning driver output circuit indicated in the formula (14), and the input voltage correction value VVR is held in the correction amount VVR latch circuit 69-6.

In the next horizontal period, in synchronism with sequential reading of the display data from the Nth pixel by the line memory 63, the voltage drop for correction is read out and the voltage drop for correction is calculated and added. The voltage drop Vm−1 generated in the (m−1)th pixel is calculated in the following manner.

The mth diode current im is read out from the line memory 68-1 and the electric current im is added to the sum of the diode currents from the Nth pixel to the (m−1)th pixel held in the inside of the electric current ij adding circuit 68-4. From this added value, the electric current IN held in the electric current IN latch circuit 68-3 is subtracted using the electric current Im−1 calculating circuit 68-5 thus calculating the electric current Im−1 which flows into the mth pixel from the (m−1)th pixel expressed by the formula (5).

The electric current Im−1 is added to the sum of current from the electric current (IN−1) which flows from the (N−1)th pixel to the Nth pixel at the right end) to the electric current Im which flows from the mth pixel to the (m+1)th pixel held in the inside of the electric current Ij adding circuit 68-6.

The added value is multiplied with the scanning resistance r per one pixel to the Vm−1 calculating circuit 68-7, the voltage drop Vm−1 generated in the (m−1)th pixel expressed by the formula (6) is obtained. The voltage drop Vm−1 is converted into the correction data by the voltage data converting circuit 67-1 and the correction data is added to the display data held in the line memory 63 by the adding circuit 64.

Thereafter, the corrected display data is converted into the display data D0, D1, D2 corresponding to red, green, blue by the serial/parallel converting circuit 65. Further, the input voltage correction value VVL to the left-end scanning driver output circuit and the input voltage correction value VVR to the right-end scanning driver output circuit are converted into correction data DVL or DVR of m bits in the voltage data converting circuit 67-2 and the data is outputted.

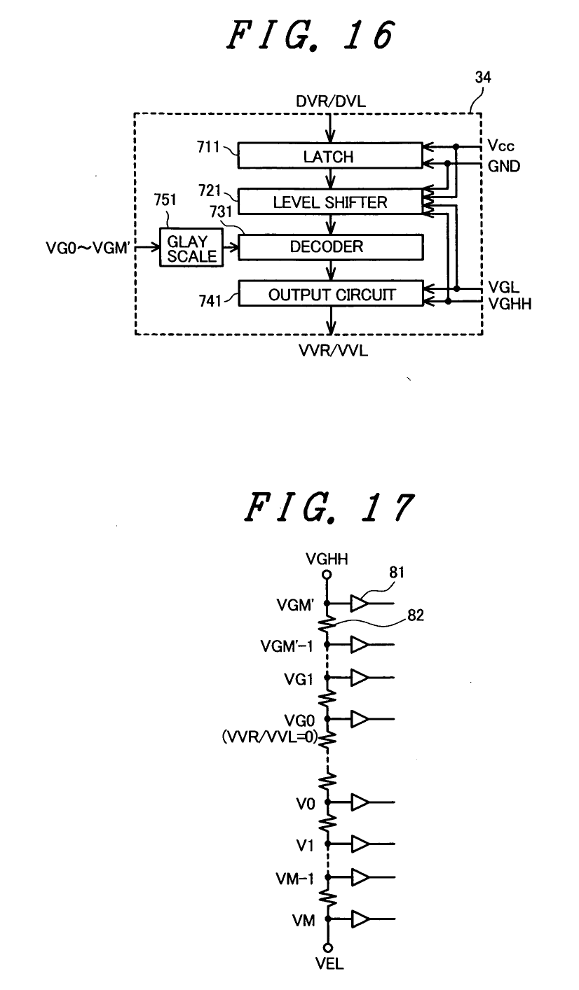

FIG. 16 is a detailed view of the correction selection voltage generating circuit 34 in the inside of the scanning driver shown in FIG. 13, wherein numeral 711 indicates a latch which holds them-bit correction data DVL or DVR which the voltage drop correcting circuit (3) outputs for every horizontal scanning period, numeral 721 indicates a level shifter which converts the latch output from a level of a logic circuit voltage Vcc-GND to a level of a high power source voltage VGHH-non-selection voltage VGL, numeral 751 indicated a gray scale voltage generating part which generates 2-to-the-power-of-m pieces of correction gray scale voltages by resistance division from the scanning circuit reference voltages VGO to VGM′ which the display controller 8 outputs, numeral 731 indicates a decoder which selects a voltage from the 2-to-the-power-of-m pieces of correction gray scale voltages corresponding to the m-bit correction data DVL or DVR which the level shifter 721 outputs, and numeral 741 is an output circuit constituted of a voltage follower for outputting the correction selection voltage VVL or VVR which the decoder outputs to the selected horizontal line.

Here, the scanning circuit reference voltages VG0 to VGM′ are voltages which are dividing a range of voltage from the selection voltage when the correction is not performed to the selection voltage when the correction becomes maximum equally, wherein all of the divided resistance values of the resistances which constitute the gray scale voltage generating part 751 are equal and hence, the relationship between the correction gray scale and the output voltage is made linear.

In FIG. 16, the m-bit correction data DVL or DVR which is outputted from the voltage drop correction circuit (3) for every horizontal scanning period is held by the latch 711 and, thereafter, has the level thereof shifted by the level shifter 721, and is inputted to the decoder 731. As a result, one of correction gray scale voltages generated in the gray scale voltage generating part 751 is selected and is outputted from the output circuit 741.

FIG. 17 is a view showing the reference voltage generating circuit which is provided in the inside of the display controller 8 shown in FIG. 12, wherein numeral 82 indicates a resistance ladder, and numeral 81 indicates a buffer amplifier for outputting respective node voltages of the resistance ladder. To both ends of the resistance ladder 82, the high power source voltage VGHH which is inputted into the scanning driver and the maximum light emitting voltage VEL which is inputted into the data driver are applied.

A resistance ratio of the resistance ladder 82 is determined such that the modulation circuit reference voltages V0 to VM assume voltages which are obtained by equally dividing a range of voltage from a non-light-emitting voltage VEH to a maximum light-emitting-voltage VEL into M sections and the scanning circuit reference voltages VG0 to VGM′ assume voltages which are obtained by equally dividing a range of selection voltage from a point of time that correction is not made to a point of time that the correction becomes maximum into M′ sections.

In this embodiment, the modulation circuit reference voltages V0 to VM and the scanning circuit reference voltages VG0 to VGM′ are generated from the same power source which includes the high power source voltage VGHH inputted into the scanning driver and the maximum light emitting voltage VEL inputted to the data driver based on the division by resistance and hence, even when the power source voltage value is fluctuated, it is possible to maintain a relative value between the modulation circuit reference voltages V0 to VM and the scanning circuit reference voltages VG0 to VGM′ to a fixed value. Accordingly, even when the correction is made in both of the modulation circuit and the scanning circuit, the generation of error can be minimized.

In this embodiment, due to the provision of the correction selection voltage generating circuit 34, the selection voltage which is inputted to the scanning driver output circuit is corrected such that the voltage drop at the scanning driver output point of the selected horizontal line becomes zero without depending on the display data and the scanning driver output voltage always assumes a fixed selection voltage VGH. Further, the data driver output voltage is corrected with the correction value which compensates for the voltage drops at respective portions of the horizontal line which are determined in response to a display pattern in a state that a voltage drop amount at the scanning circuit output point is zero.

As a result, the data driver output voltage no more contains the correction of the voltage drop generated by the scanning driver ON resistance and hence, an amplitude of the data driver output can be made small whereby it is possible to obtain advantageous effects such as the reduction of the power consumption and the reduction of the number of correction gray scales in the inside of the data driver.

Further, the scanning circuit which is constituted of the scanning driver is provided to both sides of the display panel so as to simultaneously drive the same horizontal line from both sides of the display panel and, at the same time, the correction selection voltage generating circuit is provided for every left and right scanning circuits, and the correction is made such that the voltages of the scanning driver output points which constitute the scanning circuits for the horizontal lines which are selected for every left and right scanning circuits assume fixed values without depending on the display data.

As a result, even when the scanning circuits are provided at both sides of the display panel, the data driver output voltages do not contain the correction of voltage drop generated by the scanning driver ON resistance and hence, the amplitude of the data driver output voltage can be made small whereby it is possible to obtain advantageous effects such as the reduction of power consumption and the reduction of the number of correction gray scales in the inside of the data driver.

Further, the total current which flows toward electron emission elements at end portions of the horizontal line from the scanning circuit output point is obtained by superposing components which flow toward the respective electron emission elements from the scanning circuit output point in the diode current which flows from the horizontal line to the longitudinal line of the respective electron emission elements, and the electric currents which flow from the horizontal lines to the longitudinal lines in the electron emission elements ranging from the scanning circuit output point to the mth electron emission elements are sequentially added, and the electric current which flows between the neighboring pixels is obtained by subtracting such an electric current from the total current, and the resistance value per one pixel is multiplied to the value which is sequentially adding the inter-neighboring-pixel currents from the scanning circuit output point to the mth pixel whereby the inter-neighboring-pixel voltage dropt can be obtained and the voltage drop at each electron emission element can be obtained.

As a result, with respect to a sum-of-product operation during one horizontal scanning period, it is sufficient to perform only the N×N sum-of-product operation for calculating the total current IN. Although the N×N sum-of-product operation is performed N times in the conventional method, the number of the sum-of-product operation can be drastically reduced by 1/N times.

### Embodiment 6

In this embodiment, a scanning driver output voltage VX is detected, the scanning driver output voltage VX is compared with a predetermined selection voltage VGH, and an input voltage VO to a scanning driver output circuit is changed such that a voltage at an output point of a scanning driver assumes the predetermined selection voltage VGH.

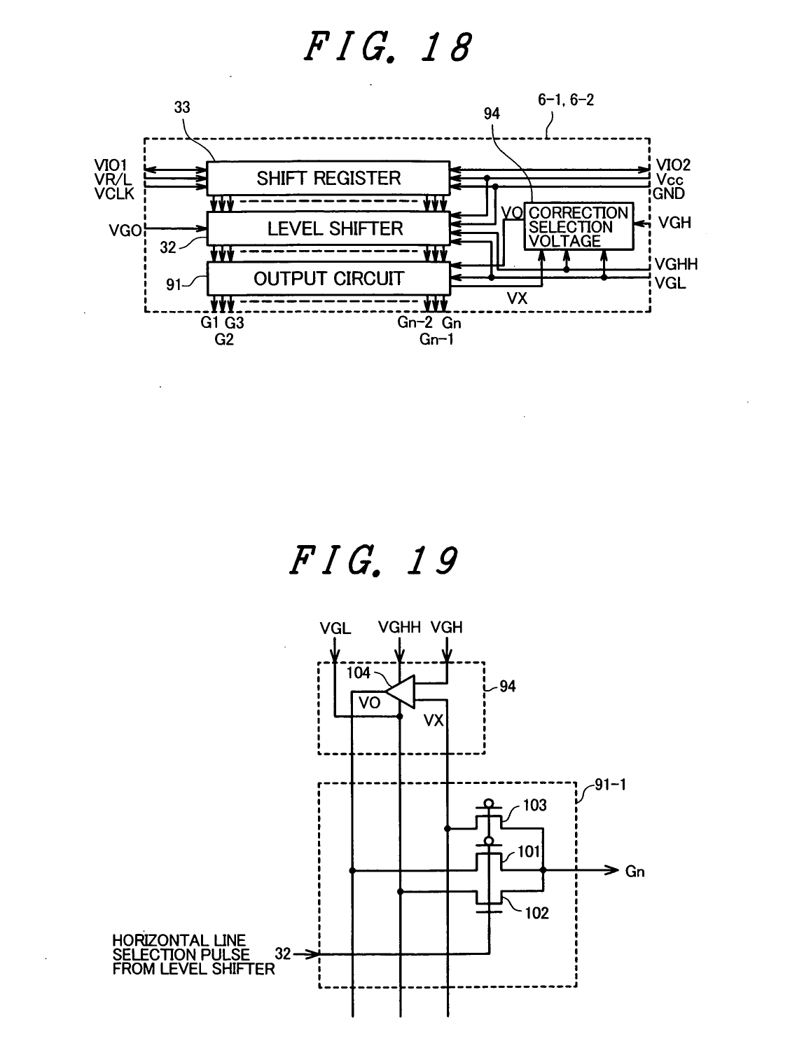

FIG. 18 is a constitutional view of the scanner driver of this embodiment. In the drawing, parts identical with the parts shown in FIG. 13 are given same symbols. Numeral 91 indicates an output circuit which outputs the selection voltage VGH or a non-selection voltage VGL to respective horizontal lines 2 of a display panel 4 as output voltages G1 to Gn in response to shift register outputs whose levels are shifted, and numeral 94 indicates a correction selection voltage generating circuit which generates a correction selection voltage VO inputted to the output circuit 91.

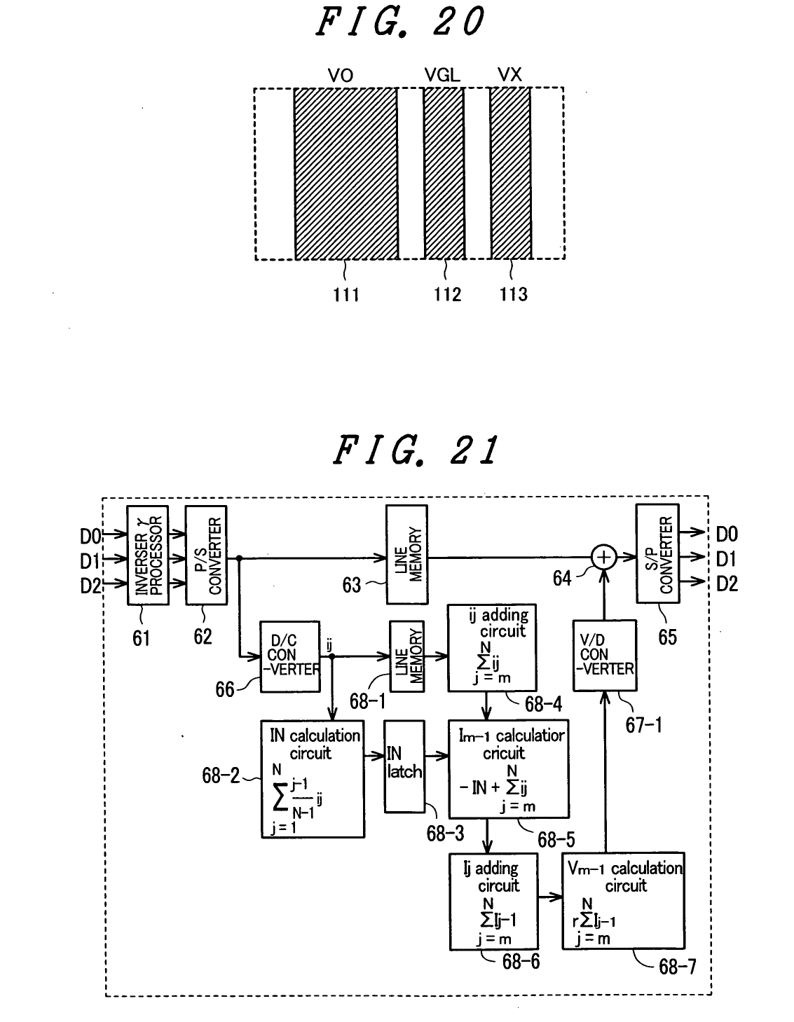

FIG. 19 shows the detail of the output circuit 91 and the correction selection voltage generating circuit 94 in the inside of the scanning driver shown in FIG. 18. Numeral 91-1 indicates a unit of the output circuit provided for every horizontal line. Numeral 102 indicates an nMOS switch which turns on or off the non-selection voltage VGL, while numeral 101 indicates a pMOS switch which turns on or off the correction selection voltage VO which the correction selection voltage generating circuit 94 generates, numeral 103 indicates a detection pMOS which transmits the output voltage Gn of the output circuit of the selected horizontal line as the input voltage VX to the correction selection voltage generating circuit 94. Further, numeral 104 indicates a differential amplifier which outputs the correction selection voltage VO such that an input voltage VX from the output circuit unit 91-1 becomes equal to the horizontal line selection voltage VGH when an electric current does not flow into the horizontal line and the correction is no performed.

In FIG. 18, when a horizontal line selection pulse is outputted from the level shifter 32 in the same manner as the scanner driver shown in FIG. 13, as shown in FIG. 19, the nMOS switch 102 of the selected horizontal line is turned off and the PMOS switch 101 of the selected horizontal line is turned on and hence, the output voltage Gn rises to the selection voltage VGH from the non-selection voltage VGL.

Here, the differential amplifier 104 in a steady state outputs the correction selection voltage VO such that the input voltage VX from the output circuit unit 91-1 becomes equal to the horizontal line selection voltage VGH when the electric current does not flow into the horizontal line and the correction is no performed. At this point of time, the electric current does not flow in the pMOS switch 103 and hence, the output voltage Gn becomes equal to the input voltage VX. That is, the output voltage Gn becomes always equal to the horizontal line selection voltage VGH.

FIG. 20 is an arrangement view of lines between the unit 91-1 of each output circuit and the correction selection voltage generating circuit 94 which are provided for every line. In the drawing, numeral 111 indicates a differential amplifier output line which connects the pMOS switch 101 in the inside of the unit 91-1 of each output circuit and the output of the differential amplifier 104 in the inside of the correction selection voltage generating circuit 94, numeral 112 indicates a power source line which supplies the non-selection voltage VGL to the nMOS switch 102 in the inside of the unit 91-1 of each output circuit, and numeral 113 indicates a differential amplifier input line which connects the detection PMOS 103 in the inside of the unit 91-1 of each output circuit and the input of the differential amplifier 104 in the inside of the correction selection voltage generating circuit 94. In this embodiment, the power source line 112 is arranged between the differential amplifier output line 111 and the differential amplifier input line 113 thus preventing the generation of a parasitic capacitance between the input and the output of the amplifier.

FIG. 21 is a detailed view of the voltage drop correction circuit (4) of this embodiment. In the drawing, parts identical with the parts described in the above-mentioned embodiments are given same symbols.

In the voltage drop correction circuit (4), the correction of the display data is performed in the same manner as FIG. 15. Hereinafter, the manner of operation is explained. The inputted 3-output display data of n bits D0, D1, D2 which correspond to red, green, blue are, after being subjected to the inverse gamma correction based on the relationship between the drive voltage and the light emitting characteristic of the display panel 4 in the inverse gamma processing part 61, converted into the serial data which conforms to the arrangement on the display panel 4 by the parallel/serial converting circuit 62, and is sequentially written in the line memory 63. In parallel with such an operation, the serial data which is subjected to the P/S conversion is inputted to the data current conversion part 66 and, after being converted into the diode current ij, the serial data is inputted to the correction voltage calculation means 68-1 to 68-7. The voltage drop Vm−1 which is calculated based on the formula (6) is converted into the correction data by the voltage/data conversion circuit 67-1, and is added to the display data held by the line memory 63 in the adding circuit 64. Thereafter, the corrected display data is converted into the display data D0, D1, D2 corresponding to red, green, blue in the S/P converting circuit 65.

In this embodiment, the correction selection voltage generating circuit 94 detects the output voltage VX of the scanning driver output circuit 91-1, compares the output voltage VX with the predetermined voltage VGH, and changes the input voltage VO to the scanning driver output circuit 91-1 so as to make the output voltage Gn of the scanning driver output circuit 91-1 equal to the horizontal line selection voltage VGH when the correction is not performed without depending on the display data. As a result, in the same manner as the embodiment 1, the correction amount of the data driver output voltage no more contains the correction of the voltage drop generated by the scanning driver ON resistance and hence, the data driver output voltage can be lowered whereby it is possible to obtain the reduction of the power consumption and the reduction of the number of correction gray scales in the inside of the data driver.

Further, since the input impedance of the differential amplifier 104 is high, a steady-state current does not flow into the PMOS switch 103 whereby the output voltage Gn of the scanning driver output circuit 91-1 and the input voltage VX of the differential amplifier 104 become equal. Accordingly, it is also possible to correct the voltage drop attributed to the line resistance from the differential amplifier 104 which constitutes the correction selection voltage generating circuit 94 to the pMOS switch 101 of the scanning driver output circuit 91-1. Further, it is also possible to obtain an advantageous effect that even when the ON resistance of the scanning driver output circuit 91-1 varies for every output, it is possible to always set the output voltage Gn equal to the horizontal line selection voltage VGH. On the other hand, compared to the embodiment 1, the correction selection voltage generating circuit 94 is constituted of only the differential amplifier and, the voltage drop correction circuit (4) does not require the circuit for calculating the scanning driver output voltage correction value and hence, it is possible to simplify the hardware.

### Embodiment 7

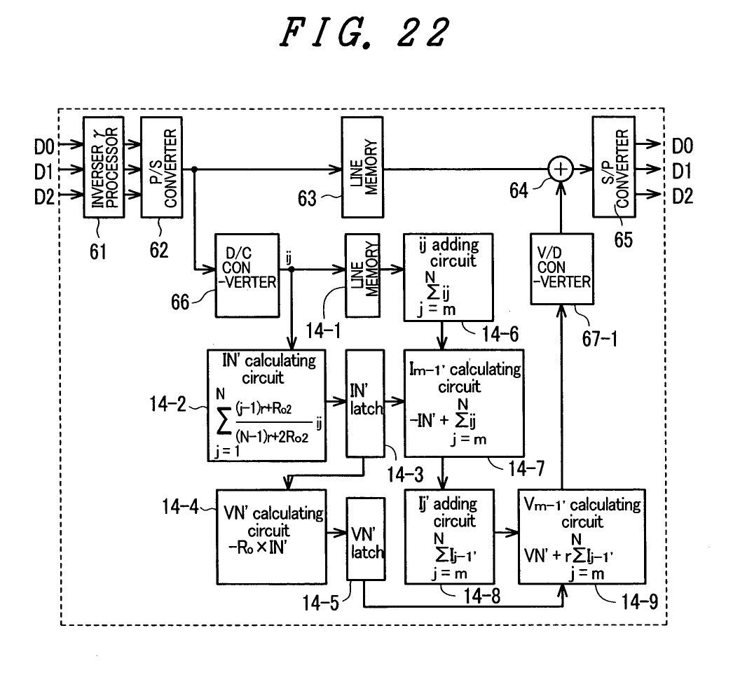

FIG. 22 shows the detail of the voltage drop correction circuit (5). The voltage drop correction circuit (5) is arranged in the inside of the display controller 8 shown in FIG. 12 and outputs 3-output display data D0, D1, D2 of n bits to a modulation circuit 5. Other portion of the display controller 8 receives image signals from the outside of the display device and transmits 3-output display data D0, D1, D2 of n bits corresponding to red, green, blue to the voltage drop correction circuit (5), and outputs control signals to the modulation circuit 5 and the scanning circuits 6-1, 6-2.

In FIG. 14, parts identical with the parts described in the embodiments are given same symbols. Further, numerals 14-1 to 14-9 indicate correction voltage calculating means for calculating correction voltages. Further, parts 14-1, 14-3, 14-6, 14-7, 14-8 are substantially equal to the parts 68-1, 68-3, 68-4, 68-5, 68-6 in FIG. 15 and FIG. 21.

Numeral 14-2 indicates an IN′ calculating circuit which calculates an electric current IN′ which flows from the ground point to the Nth pixel at the right end expressed by the formula (12) by multiplying the diode current values ij and coefficients of the respective pixels and by sequentially adding the multiplication values, numeral 14-4 indicates a voltage drop VN′ calculating circuit which obtains a voltage drop VN′ at the Nth pixel shown in the formula (11) by multiplying the electric current IN′ and the coefficients, 14-5 indicates a voltage drop VN′ latch circuit which holds the calculated voltage drop VN′, and 14-9 indicates a Vm−1′ calculating circuit which obtains the voltage drop Vm−1′ generated in the (m−1)th pixel shown in the formula (13) by adding a value which is obtained by multiplying the scanning line resistance r per one pixel to the added value from the electric current Ij adding circuit 14-8 to the voltage drop VN′ held in the latch circuit 14-5.

In the voltage drop correction circuit (5), the correction of the display data is performed in the same manner as FIG. 15. The 3-output display data of n bits D0, D1, D2 which correspond to red, green, blue is, after being subjected to the inverse gamma correction based on the relationship between the drive voltage and the light emitting characteristic of the display panel 4 in the inverse gamma processing part 61, converted into the serial data which conforms to the arrangement on the display panel 4 by the parallel/serial converting circuit 62, and is sequentially written in the line memory 63. In parallel with such an operation, the serial data which is subjected to the P/S conversion is inputted to the data current conversion part 66 and, after being converted into the diode current ij, the serial data is inputted to the correction voltage calculation means 14-1 to 14-9. The voltage drop Vm−1′ which is calculated based on the formula (13) is converted into the correction data by the voltage/data conversion circuit 67-1, and is added to the display data held by the line memory 63 in the adding circuit 64. Thereafter, the corrected display data is converted into the display data D0, D1, D2 corresponding to red, green, blue in the S/P converting circuit 65.

In this embodiment, by correcting the data driver output voltage while taking the resistance Ro2 from the scanning driver output point to the pixels at both ends into consideration, it is possible to realize the highly accurate correction.

### Embodiment 8

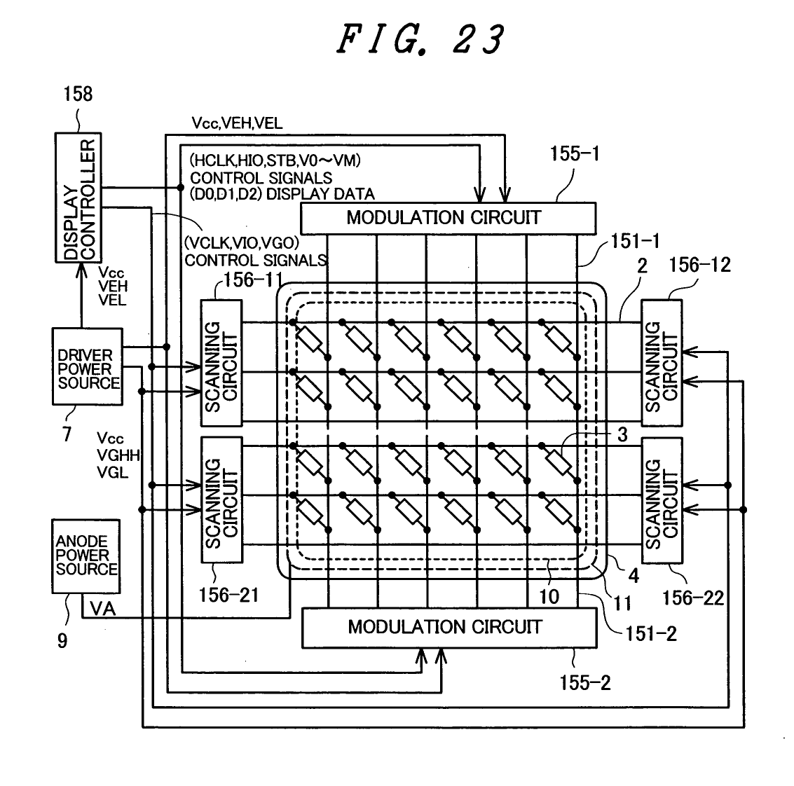

FIG. 23 is another whole constitutional view according to the invention, wherein the screen is divided into upper and lower blocks and images are simultaneously displayed on the upper and lower blocks.

Numerals 151-1, 151-2 indicate longitudinal lines which are divided at the center of the display panel 4, numerals 155-1, 155-2 indicate modulation circuits which respectively output modulation signals to the upper and lower longitudinal lines, numerals 156-11, 156-12 indicate scanning circuits which are arranged on both sides of the display panel 4 and perform the horizontal line selection of the upper portion of the screen, and numerals 156-21, 156-22 indicate scanning circuits which are arranged on both sides of the display panel 4 and perform the horizontal line selection of the lower portion of the screen.

The driver power source 7 supplies a high supply voltage VGHH, a non-selection voltage VGL and a logic circuit voltage Vcc to the scanning circuits 156-11, 156-12, 156-21, 156-22. Further, the driver power source 7 supplies a maximum light emitting voltage VEL, a non-light emitting voltage VEH and a logic circuit voltage Vcc to the modulation circuits 155-1, 155-2 and the display controller 158.

The display controller 158 outputs a vertical clock VCLK, a start pulse VIO, a selection period signal VGO to the scanning circuits 156-11, 156-12, 156-21, 156-22, and outputs a horizontal clock HCLK, a start pulse HIO, an output changeover signal STB, the 3-output display data D0, D1, D2 corresponding to red, green, blue of n-bit and reference voltages V0 to VM to the modulation circuits 155-1, 155-2. Among these control signals, all signals except for the reference voltages V0 to VM have amplitude of the logic circuit voltage Vcc. Here, corresponding to red, green, blue, 3-output display data D0, D1, D2 of n bits which differ from each other between the modulation circuits 155-1, 155-2 are inputted.

The constitution and the manner of operation of the modulation circuits 155-1, 155-2 and the constitution and the manner of operation of the scanning circuits 156-11, 156-12, 156-21, 156-22 are equal to those constitution and the manner of operation of the second embodiment. Two voltage drop correction circuits are provided in the inside of the display controller 158, wherein the inputted 3-output display data D0, D1, D2 of n bits are simultaneously outputted to the respective modulation circuits 155-1, 155-2. A frame memory is mounted in another portion of the display controller 158, receives the video signals from the outside of the display device, and outputs the 3-output display data D0, D1, D2 of n bits corresponding to red, green, blue to the voltage drop correction circuit corresponding to the upper and lower blocks. Further, the control signals are outputted to the modulation circuits 155-1, 155-2 and the scanning circuits 156-1, 156-2.

In this embodiment, the screen is divided into the upper and lower blocks and the image is simultaneously displayed on the upper and lower blocks. As a result, the display time for one horizontal line can be increased twice compared to the related art. Accordingly, assuming that the brightness is equal, the electric current which flows in the horizontal line can be halved and the voltage drop amount to be corrected can be halved. Further, since the longitudinal lines are divided, the drive capacities of the modulation circuits 155-1, 155-2 can be halved, and the power which is consumed by the modulation circuits 155-1, 155-2 can be halved.

Above described constitution, the correction selection voltage generating circuit 34 or a correction selection voltage generating circuit 94 is provided for every scanning driver. However, the correction selection voltage generating circuit 34 or the correction selection voltage generating circuit 94 may be provided for every independently operating scanning circuit. That is, when the scanning circuits 6-1, 6-2 are arranged at both sides of the display panel 4, the correction selection voltage generating circuit 34 or the correction selection voltage generating circuit 94 may be provided for every scanning circuit 6-1, 6-2. Further, when the screen is divided into upper and lower blocks and images are simultaneously displayed on the upper and lower blocks, the correction selection voltage generating circuit may be provided for every scanning circuit 156-11, 156-12, 156-21, 156-22.

Further, although the data driver output voltage is corrected in consideration of the resistance Ro2 to the pixels at both ends from the scanning driver output point, it is also possible to correct the data driver output voltage in the same manner using the constitution of the embodiment 5.

There may be a case that the resistance Ro2 to the pixels at both ends from the scanning driver output point differs for every horizontal line due to the line arrangement. In such a case, using Ro2 which differs for every horizontal line, a coefficient is calculated. Due to such a provision, it is possible to prevent the degradation of image qualities which is generated due to the irregularities of the resistance Ro2 to both-end pixels from the scanning driver output point.

What is claimed is:

1. A display device comprising:
a display panel having a back plate on which a plurality of horizontal lines and a plurality of longitudinal lines;
a scanning circuit which performs the selection of the horizontal lines; and
a modulation circuit which applies a modulation voltage to the longitudinal lines, wherein
the scanning circuit includes, for every horizontal line:
a non-selection switch which is provided between a scanning circuit output point and a power source line and turns on and off a non-selection voltage;
a selection switch which is provided between a scanning circuit output point and a correction selection voltage generating circuit output line and turns on or off a correction selection voltage; and
a detection switch which is provided between the scanning circuit output point and a correction selection voltage generating circuit input line and detects an output voltage of the selected horizontal line, and,
the scanning circuit further includes a correction selection voltage generating circuit having a differential amplifier which connects a first input thereof to the correction selection voltage generating circuit input line, a second input thereof to a line to which the horizontal line selection voltage is applied, and an output thereof to the correction selection voltage generating circuit output line for every line of the plurality of horizontal lines.

2. A display device according to claim 1, wherein the correction selection voltage generating circuit includes a feedback switch between an input and an output of the differential amplifier.

3. A display device according to claim 2, wherein an OFF time of the feedback switch is delayed than ON times of the selection switch and the detection switch.

4. A display device comprising:
a display panel having a back plate on which a plurality of horizontal lines, a plurality of longitudinal lines and a plurality of electron emission elements which are connected with the horizontal lines and the longitudinal lines are formed and a face substrate to which an anode voltage is applied;
a scanning circuit which performs the selection of the horizontal lines; and
a modulation circuit which applies a modulation voltage to the longitudinal lines, wherein
the display device includes a correction selection voltage generating circuit which performs the correction such that the voltage of the scanning circuit output point of the selected horizontal line assumes a fixed value without depending on display data, and the modulation circuit output outputs a modulation voltage which is corrected based on a correction value for compensating for a voltage drop in each horizontal line portion which is determined corresponding to a display pattern while setting an amount of voltage drop at a scanning circuit output point to zero.

5. A display device according to claim 4, wherein a total electric current which flows toward electron emission elements at ends of the horizontal line from the scanning circuit output point is obtained by superposing components which flow toward the respective electron emission elements from the scanning circuit output point out of the electric current which flows from horizontal lines to longitudinal lines of the respective electron emission elements,
the electric current which flows from the horizontal lines to the longitudinal lines up to the mth electron emission element from the scanning circuit output point is sequentially added, and the added electric current is subtracted from the total electric current thus obtaining an electric current which flows between neighboring pixels,
a resistance value per one pixel is multiplied to a value which is obtained by sequentially adding the inter-neighboring-pixel electric currents up to the mth electron emission element from the scanning circuit output point thus obtaining an inter-neighboring-pixel voltage drop, and
a voltage drop in each electron emission element is obtained.

6. A display device according to claim 4, wherein correction value of the modulation voltage compensates for the voltage drop attributed to the resistance between the electron emission element which is arranged at an end portion of the horizontal line and the scanning circuit output point.

7. A display device according to claim 6, wherein the value of the resistance differs for every horizontal line.

8. A display device comprising:
a display panel having a back plate on which a plurality of horizontal lines, a plurality of longitudinal lines and a plurality of electron emission elements which are arranged at respective intersecting points of the horizontal lines and the longitudinal lines are formed and a face substrate to which an anode voltage is applied;
a scanning circuit which performs the selection of the horizontal lines; and
a modulation circuit which applies a modulation voltage to the longitudinal lines, wherein
the scanning circuit includes a correction selection voltage generating circuit which is provided to both sides of one horizontal line and performs the correction such that a voltage of a scanning circuit output point of the selected horizontal line assumes a predetermined value, and
the modulation circuit outputs a modulation voltage which is corrected based on a corrected value for compensating for voltage drops on respective portions of the horizontal line which are determined corresponding to a display pattern.

9. A display device according to claim 8, wherein a total electric current which flows toward electron emission elements at end portions of the horizontal line from the scanning circuit output point is obtained by superposing components which flow toward the respective electron emission elements from the scanning circuit output point out of the electric current which flows from horizontal lines to longitudinal lines of the respective electron emission elements,
the electric current which flows from the horizontal lines to the longitudinal lines up to the mth electron emission element from the scanning circuit output point is sequentially added, and the added electric current is subtracted from the total electric current thus obtaining an electric current which flows between neighboring pixels,
a resistance value per one pixel is multiplied to a value which is obtained by sequentially adding the inter-neighboring-pixel electric currents up to the m th electron emission element from the scanning circuit output point thus obtaining an inter-neighboring-pixel voltage drop, and
a voltage drop in each electron emission element is obtained.

10. A display device according to claim 8, wherein correction value of the modulation voltage compensates for the voltage drop attributed to the resistance between the electron emission element which is arranged at an end portion of the horizontal line and the scanning circuit output point.

11. A display device according to claim 10, wherein the value of the resistance differs for every horizontal line.

12. A display device comprising:
a display panel having a back plate on which a plurality of horizontal lines, a plurality of longitudinal lines and a plurality of electron emission elements which are connected with the horizontal lines and the longitudinal lines are formed and a face substrate to which an anode voltage is applied;
a scanning circuit which performs the selection of the horizontal lines; and
a modulation circuit which applies a modulation voltage to the longitudinal lines, wherein
the scanning circuit includes, for every horizontal line:
a non-selection switch which is provided between a scanning circuit output point and a power source line and turns on and off a non-selection voltage;
a selection switch which is provided between a scanning circuit output point and a correction selection voltage generating circuit output line and turns on or off a correction selection voltage; and
a detection switch which is provided between the scanning circuit output point and a correction selection voltage generating circuit input line and detects an output voltage of the selected horizontal line, and,
the scanning circuit further includes a correction selection voltage generating circuit having a differential amplifier which connects a first input thereof to the correction selection voltage generating circuit input line, a second input thereof to a line to which the horizontal line selection voltage is applied, and an output thereof to the correction selection voltage generating circuit output line for every line of the plurality of horizontal lines.
